(19) United States
(12) Patent Application Publication
(10) Pub. No.: US 2026/0188122 A1
(43) Pub. Date: Jul. 2, 2026

(54) GROUP RIDE RANGE MONITORING SYSTEM

(71) Applicant: Polaris Industries Inc., Medina, MN (US)

(72) Inventor: Scott Taylor, Blaine, MN (US)

(21) Appl. No.: 19/433,307

(22) Filed: Dec. 26, 2025

Related U.S. Application Data
(60) Provisional application No. 63/739,989, filed on Dec. 30, 2024.

(51) Int. Cl. G08G 1/00; G01C 21/34; G01C 21/36; G07C 5/00

(52) U.S. Cl. CPC G08G 1/22; G01C 21/3438; G01C 21/367; G07C 5/004; G07C 5/008

(57) ABSTRACT

The present disclosure provides a method for monitoring range limitations in a group ride. The method includes receiving status data from a plurality of vehicles participating in a group ride via a wireless communication interface, analyzing the status data to determine a range limitation for each vehicle using a processor, identifying a most constrained range limitation as a group range limitation, transmitting the group range limitation to each vehicle, and automatically managing travel of each vehicle within the group range limitation. The status data comprises at least one of fuel level data, battery charge data, diagnostic data, time constraints, and geographical boundary constraints. The method enables coordinated group travel by ensuring all vehicles operate within the capabilities of the most constrained vehicle in the group.

### CROSS-REFERENCE TO RELATED APPLICATIONS

This application claims priority from U.S. Provisional Patent Application 63/739,989 filed Dec. 30, 2024, the entire reference is hereby incorporated by reference.

### BACKGROUND

Recreational vehicles, such as all-terrain vehicles (ATVs), utility vehicles (UVs), side-by-side vehicles, and snowmobiles, have gained significant popularity for both leisure and utility purposes. As the use of recreational vehicles continues to grow, so does the trend of group rides, where multiple riders embark on journeys together. Group rides present unique challenges in coordination and management to ensure that all participants can complete the planned route. For example, the range capabilities of recreational vehicles can vary significantly based on factors such as fuel capacity, battery life for electric models, vehicle specifications, and terrain conditions. In a group setting, these variations can lead to situations where some vehicles may be at risk of running out of fuel or battery power before reaching the destination or a refueling point. Traditional methods of managing group rides often rely on manual tracking and communication between riders, which may be inefficient and prone to errors. Additionally, riders may not always be aware of the limitations of their own vehicles or those of other participants in the group.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The increasing integration of technology in recreational vehicles has opened up new possibilities for enhancing the group ride experience. However, many existing systems focus primarily on individual vehicle performance or basic GPS tracking, without fully addressing the complexities of coordinating multiple vehicles with varying capabilities over extended journeys. There is a growing need for comprehensive solutions that can effectively monitor and manage the range limitations of all vehicles participating in a group ride. Such solutions could potentially improve safety, enhance ride planning, and ultimately provide a more enjoyable experience for all participants. The present disclosure relates to vehicle monitoring and communication systems, and more particularly to a group ride range monitoring system for coordinating multiple vehicles based on range limitations and trail conditions.

According to an aspect of the present disclosure, a method for monitoring range limitations in a group ride is provided. The method includes receiving, via a wireless communication interface, from a plurality of vehicles participating in a group ride, status data including at least one of fuel level data, battery charge data, diagnostic data, time constraints, and geographical boundary constraints. The method includes analyzing, using a processor, the status data to determine a range limitation for each vehicle of the plurality of vehicles. The method includes identifying, using the processor, a most constrained range limitation from among the determined range limitations as a group range limitation. The method includes transmitting, via the wireless communication interface, to each vehicle of the plurality of vehicles, the group range limitation. The method includes automatically managing, using the processor, travel of each vehicle in the group ride within the group range limitation.

According to other aspects of the present disclosure, the method may include one or more of the following features. The method may include receiving trail regulation data for a planned route of the group ride, and evaluating, using the processor, vehicle compatibility with the trail regulation data, wherein the trail regulation data comprises at least one of trail width restrictions, vehicle size limitations, and trail difficulty ratings. The method may include generating, via the processor, an alert when a vehicle in the group ride approaches the group range limitation. The transmitting may comprise displaying the most constrained range limitation and an identifier of a vehicle associated with the most constrained range limitation on a graphical user interface of each vehicle of the plurality of vehicles. The transmitting may comprise displaying a map interface showing locations of the plurality of vehicles with visual indicators of their respective range limitations on a graphical user interface of each vehicle. The method may include receiving a destination location for the group ride, determining whether the most constrained range limitation permits completion of a route to the destination location, and generating a warning notification when the most constrained range limitation is insufficient for completing the route. The transmitting, to each vehicle of the plurality of vehicles, the group range limitation, may comprise transmitting to at least one of: a display device integrated with each vehicle, a mobile device associated with each vehicle, and a remote monitoring station. The method may include adjusting the group range based on real-time updates of status data.

According to another aspect of the present disclosure, a system for coordinating group vehicle travel is provided. The system includes a communication interface configured to collect status data from a plurality of vehicles in a group. The system includes a processor configured to analyze the status data to determine individual range capabilities for each vehicle, determine group travel constraints based on a most limited range capability among the individual range capabilities, and generate alerts when at least one vehicle approaches the group travel constraints. The system includes a display configured to present the alerts to operators of the plurality of vehicles.

According to other aspects of the present disclosure, the system may include one or more of the following features. The status data may comprise at least one of: fuel level data, battery charge level data, diagnostic trouble codes, vehicle specification data, time constraints, and geographical boundary constraints. The processor may be further configured to receive trail regulation data for a planned route, and determine whether each vehicle's specifications comply with the trail regulation data. The display may comprise a map interface showing locations of the plurality of vehicles with visual indicators representing their respective range capabilities, and the visual indicators may comprise color-coded icons that change appearance when a vehicle approaches the group travel constraints. The processor may be further configured to receive a destination location, calculate whether the most limited range capability permits completion of a route to the destination location, and generate a warning notification when the most limited range capability is insufficient for completing the route. The alerts may be transmitted to at least one of: an in-vehicle display device, a mobile device associated with a vehicle operator, and a remote monitoring station.

According to another aspect of the present disclosure, a vehicle is provided. The vehicle includes a telematic control unit configured to communicate with other vehicles in a group ride. The vehicle includes sensors configured to monitor vehicle operating parameters affecting vehicle range. The vehicle includes a processor configured to determine a vehicle range based on the operating parameters, receive range information from the other vehicles, compare the vehicle range with ranges of the other vehicles, and generate an alert when any vehicle in the group ride approaches a range limitation. The vehicle includes a display configured to present the alert.

According to other aspects of the present disclosure, the vehicle may include one or more of the following features. The operating parameters may comprise at least one of: fuel level, battery charge level, diagnostic trouble codes, and vehicle specifications affecting trail compatibility. The processor may be further configured to receive trail regulation data for a planned route, and determine whether the vehicle specifications comply with the trail regulation data. The display may comprise a map interface showing locations of the vehicles in the group ride and visual indicators representing their respective ranges. The visual indicators may comprise color-coded icons that change appearance based on remaining range. The processor may be further configured to receive a destination location for the group ride, calculate whether the ranges of all vehicles permit completion of a route to the destination location, and generate a warning notification when any vehicle's range is insufficient for completing the route.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a schematic diagram of a vehicle control system, according to aspects of the present disclosure.

FIG. 2 depicts a block diagram of a vehicle control system, in accordance with example embodiments.

FIG. 3 shows a block diagram of a vehicle control system for a recreational vehicle, according to an embodiment.

FIG. 4 illustrates another block diagram of a vehicle control system for a recreational vehicle, according to aspects of the present disclosure.

FIG. 5 depicts a block diagram of a group ride range monitoring system, in accordance with example embodiments.

FIG. 6 shows a system diagram of a group ride communication system, according to an embodiment.

FIG. 7 illustrates a system diagram of a group ride system, according to aspects of the present disclosure.

FIG. 8 depicts a system diagram of a group ride communication system, in accordance with example embodiments.

FIG. 9 shows a flowchart for a method of managing a group ride for vehicles, according to an embodiment.

FIG. 10 illustrates a sequence diagram for a group vehicle range monitoring and communication system, according to aspects of the present disclosure.

FIG. 11 depicts another sequence diagram for a group vehicle range monitoring and communication system, in accordance with example embodiments.

FIG. 12 shows a sequence diagram for a group vehicle monitoring and communication system, according to an embodiment.

FIG. 13 illustrates another sequence diagram for a group vehicle monitoring and communication system, according to aspects of the present disclosure.

FIG. 14 depicts an orthogonal front view of a rider computing device, in accordance with example embodiments.

FIG. 15 shows a user interface for a group ride management system, according to an embodiment.

FIG. 16 illustrates a split-screen interface for a group riding application, according to aspects of the present disclosure.

FIG. 17 depicts a user interface for a group ride monitoring system, in accordance with example embodiments.

FIG. 18 shows an orthogonal front view of a user interface for a group messaging system, according to an embodiment.

FIG. 19 illustrates an orthogonal front view of a user interface for a group ride monitoring system, according to aspects of the present disclosure.

FIG. 20 depicts an orthogonal front view of a display device for a group ride monitoring system, in accordance with example embodiments.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The following terms shall have the following meanings:

The term “comprising” and derivatives thereof are not intended to exclude the presence of any additional component, step, or procedure, whether or not the same is disclosed herein. To avoid any doubt, all compositions claimed herein through the use of the term “comprising” may include any additional additive or compound unless stated to the contrary. In contrast, the term “consisting essentially of,” if appearing herein, excludes from the scope of any succeeding recitation any other component, step, or procedure, except those that are not essential to operability, and the term “consisting of,” if used, excludes any component, step or procedure not specifically delineated or listed. The term “or,” unless stated otherwise, refers to the listed members individually as well as in any combination.

The articles “a” and “an” are used herein to refer to one or more than one (i.e., to at least one) of the grammatical objects of the article. By way of example, “a peracid” means one peracid or more than one peracid. The phrases “in one embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same aspect. If the specification states a component or feature “may,” “can,” “could,” or “might” be included or have a characteristic, that particular component or feature is not required to be included or have the characteristic.

The term “about,” as used herein, can allow for a degree of variability in a value or range, for example, it may be within 10%, within 5%, or within 1% of a stated value or of a stated limit of a range.

The terms “preferred” and “preferably” refer to embodiments that may afford certain benefits under certain circumstances. However, other embodiments may also be preferred under the same or other circumstances. Furthermore, the recitation of one or more preferred embodiments does not imply that other embodiments are not useful and is not intended to exclude other embodiments from the scope of the present disclosure.

The term “optional” or “optionally” means that the subsequently described event, circumstance, or material may or may not occur or be present, and that the description includes instances where said event, circumstance, or material occurs or is present and instances where it does not occur or is not present.

Values expressed in a range format should be interpreted in a flexible manner to include not only the numerical values explicitly recited as the limits of the range but also include all of the individual numerical values or sub-ranges encompassed within that range as if each numerical value and sub-range is explicitly recited. For example, a range such as from 1 to 6 should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

As used herein, the term “status data” refers to information related to the operational state, constraints, or conditions associated with vehicles or people in vehicles participating in a group ride. Status data includes, but is not limited to: vehicle data, time constraints, geographical boundary constraints, environmental constrains, user-inputted constraints, and other relevant data. Vehicle Data may include fuel level or fuel range, battery charge level or battery range, diagnostic data (e.g., diagnostic trouble codes or performance metrics), vehicle limitations (e.g., weight capacity, speed limitations, or towing capacity). Time constraints may include schedules or time limits imposed on the group ride, including predefined start or end times. Geographical boundary constraints may include location-based restrictions, such as geofencing, restricted zones, or permissible areas of operation. Environmental constraints may include factors such as weather conditions, terrain type, or trail regulations, including trail width restrictions, vehicle size limitations, and trail difficulty ratings. User-Inputted Constraints may include constraints manually inputted into the system by a user, such as parental restrictions, driver preferences, or administrative policies. Other relevant data may include any additional information influencing the group's operation, such as traffic data, road conditions, or group-specific requirements.

As used herein, the “limitations” that may affect a group ride refers to a comprehensive set of constraints and factors that may affect the performance, safety, or feasibility of a group ride involving multiple vehicles. These limitations may include, but are not limited to: fuel or battery range limitations, vehicle-specific limitations, trail or route limitations, time constraints, geographical boundary constraints, weather-related limitations, rider skill level limitations, and maintenance-related limitations. Fuel or battery range limitations may impact the maximum distance vehicles can travel before requiring refueling or recharging. Vehicle-specific limitations, such as maximum speed, acceleration capabilities, or terrain handling abilities, may affect the overall group performance. Trail or route limitations, including width restrictions, difficulty levels, or regulatory constraints, may determine which vehicles can safely navigate the planned path. Time constraints may be imposed by group members'schedules, daylight hours, or park/trail operating hours. Geographical boundary constraints may include geofenced areas or restricted zones that certain vehicles or riders may not be permitted to enter. Weather-related limitations could affect vehicle performance or rider safety. Rider skill level limitations may influence the group's overall pace or route selection. Maintenance-related limitations, such as vehicles requiring service or experiencing mechanical issues, could affect their performance during the ride. By considering and analyzing these various limitations, the group ride range monitoring system can provide a comprehensive assessment of the group's capabilities and constraints, enabling more informed decision-making and safer, more enjoyable group rides.

As used herein, the term “vehicle” refers to a motorized conveyance designed for recreational or utility purposes, capable of participating in group rides. This may include, but is not limited to, all-terrain vehicles (ATVs), utility vehicles (UVs), side-by-side vehicles, snowmobiles, other off-road or recreational vehicles, two- and three-wheeled motorcycles, roadsters, other on-road recreational vehicles, or the like. A vehicle in the context of this invention is equipped with components necessary for group ride range monitoring, such as a telematic control unit for communication, sensors for monitoring operating parameters, a processor for range calculations and comparisons, and a display for presenting alerts and information. The vehicle is capable of transmitting and receiving status data, including fuel levels, battery charge, diagnostic information, and geographical position, to participate in coordinated group travel within defined range limitations.

As used herein, the term “recreation vehicle” refers to a motorized vehicle designed primarily for leisure and recreational activities in outdoor environments. Recreation vehicles may include, but are not limited to, all-terrain vehicles (ATVs), utility terrain vehicles (UTVs), side-by-side vehicles, snowmobiles, personal watercraft, other off-road or specialized vehicles intended for recreational use, two-and three-wheeled motorcycles, roadsters, other on-road recreational vehicles, or the like. In the context of this invention, a recreation vehicle is equipped with components necessary for participating in group rides and range monitoring, such as a telematic control unit for communication, sensors for monitoring operating parameters, a processor for range calculations and comparisons, and a display for presenting alerts and information. Recreation vehicles in this system are capable of transmitting and receiving status data, including fuel levels, battery charge, diagnostic information, and geographical position, to facilitate coordinated group travel within defined range limitations.

As used herein, the term “processor” refers to an electronic circuit capable of executing programmed instructions and performing calculations to manage the group ride range monitoring system. The processor may be a microprocessor, central processing unit (CPU), graphics processing unit (GPU), application-specific integrated circuit (ASIC), field-programmable gate array (FPGA), or any other suitable processing device. In the context of this invention, the processor is configured to analyze status data from multiple vehicles, determine range limitations, identify the most constrained vehicle, calculate group range, generate alerts, and automatically manage travel of vehicles within the determined group range limitation. The processor may be integrated into a vehicle's onboard computer system, a dedicated group ride management device, or a remote server system coordinating the group ride. Non-limiting examples of processors include vehicle controller processor (e.g., processor 242 in the vehicle controller 240), telematics control unit processor (mentioned as part of the telematics control unit 350), display processor (e.g., display processor 322), group management controller processor (implied as part of the group management controller 186), group management master controller processor (implied as part of the group management master controller 300), network controller processor (implied as part of the network controller 180), operator interface controller processor (implied as part of the operator interface controller 156), mobile device processors (implied for smartphones or tablets used in the system), remote server processors (implied for any cloud-based or centralized processing), ECU (Engine Control Unit) processor (implied as part of the ECU 12 or ECU module 544), IVI (In-Vehicle Infotainment system) processor (implied as part of the IVI module 542), RIDE Command® system processor (implied as part of the RIDE Command module 548). These processors may work together within the group ride range monitoring system to collect data, analyze information, make decisions, and manage communications between vehicles and components. They may a play role in determining range limitations, generating alerts, and coordinating group travel to ensure safe and efficient group rides.

In some examples, the processor, as part of the group ride management system, may continuously analyze the status data received from all vehicles in the group. Based on this analysis, it would determine the group range limitation and then execute algorithms to ensure each vehicle stays within that limitation. This could involve calculating optimal routes that keep all vehicles within the group range limitation, adjusting speed recommendations for individual vehicles to maintain group cohesion, generating alerts or instructions for vehicles approaching the range limit, coordinating refueling or recharging stops as needed, modifying the planned route in real-time if conditions change, and communicating updated travel parameters to each vehicle's onboard systems. The processor may work in conjunction with other components like the communication interface and display to implement these management functions effectively across the entire group of vehicles.

To automatically manage travel of each vehicle in the group ride within the group range limitation, the processor may continuously analyze real-time data from all vehicles in the group and implement control strategies to keep each vehicle within the established group range limitation. This could involve several automated actions: dynamically adjusting individual vehicle speed limits to maintain group cohesion while staying within range constraints, modifying navigation routes in real-time to optimize for the group's range capabilities, coordinating automated throttle control or regenerative braking to manage energy consumption, triggering automatic stops for refueling or recharging when necessary, implementing geofencing to prevent vehicles from straying beyond safe operational boundaries, adjusting vehicle performance parameters (e.g., power output, regenerative braking levels) to maximize efficiency, and coordinating with vehicle-to-vehicle (V2V) communication systems to maintain optimal spacing and drafting formations for energy conservation. The processor may interface with each vehicle's engine control unit (ECU), telematics control unit (TCU), and other onboard systems to implement these management functions across the entire group of vehicles, ensuring all participants remain within the calculated group range limitation throughout the ride.

As used herein, the terms “geofence” or “geofencing” refer to a virtual perimeter or boundary defined by geographical coordinates or distances from a specified location. In the context of this group ride range monitoring system, geofencing may be used to establish predetermined boundaries for the group ride, beyond which alerts may be generated, define areas with specific trail regulations or vehicle restrictions that may affect the group's travel, set safety limits for youth vehicles or less experienced riders within the group, create virtual markers for important waypoints, such as refueling stations or rest areas, monitor and enforce geographical constraints imposed by parental controls or ride organizers, automatically adjust vehicle performance parameters when entering or exiting specific geofenced areas, or facilitate the calculation of range limitations based on predefined geographical boundaries. The system may dynamically update and modify geofences based on real-time data from vehicles, trail conditions, and group ride parameters to ensure safe and compliant operation of all vehicles within the group.

The group ride range monitoring system addresses several technical problems inherent in coordinating multiple vehicles during recreational group rides: disparate vehicle capabilities, dynamic range limitations, communication challenges, safety concerns, and trail compatibility issues. Regarding disparate vehicle capabilities, different vehicles in a group may have varying fuel capacities, battery ranges, and performance characteristics, making it challenging to plan routes that accommodate all participants. With dynamic range limitations, factors such as terrain, weather, and individual driving styles can affect vehicle range in real-time, requiring constant recalculation of group capabilities. Regarding communication challenges, limited cellular coverage in remote areas can hinder traditional methods of group coordination and status sharing. With safety concerns, lack of awareness about individual vehicle limitations within the group can lead to potentially dangerous situations, such as vehicles running out of fuel or battery power in remote locations. Regarding trail compatibility issues, varying vehicle specifications may not be suitable for all trail conditions, requiring a system to match vehicle capabilities with trail regulations.

The present disclosure offers technical solutions to these problems through integrated vehicle-to-vehicle communication, real-time range calculation algorithms, centralized data processing, adaptive route planning, proactive alert system, and multi-modal user interfaces. In integrated vehicle-to-vehicle communication, a combination of short-range (e.g., Bluetooth, Wi-Fi Direct) and long-range (cellular, satellite) communication technologies may be used to ensure constant data exchange between group members, even in areas with limited connectivity. Real-time range calculation algorithms may involve sophisticated algorithms that process data from multiple vehicle sensors (fuel levels, battery charge, GPS, terrain information) to continuously update individual and group range capabilities. For centralized data processing, a group management controller may be used to aggregate and analyze data from all participating vehicles, identifying the most constrained vehicle and establishing group-wide limitations. Adaptive route planning may include integrating real-time range calculations with navigation systems to dynamically adjust routes based on current group capabilities and trail conditions. Proactive alert system may include implementing an intelligent alert generation system that warns riders of approaching range limitations, potential trail incompatibilities, or other safety concerns before they become critical issues. Multi-modal user interfaces may involve developing intuitive display systems that present complex group ride data through easily understandable visual representations, minimizing rider distraction while maximizing information conveyance. By addressing these technical challenges, the group ride range monitoring system enhances safety, improves ride planning efficiency, and ensures a more enjoyable experience for all participants in recreational group rides.

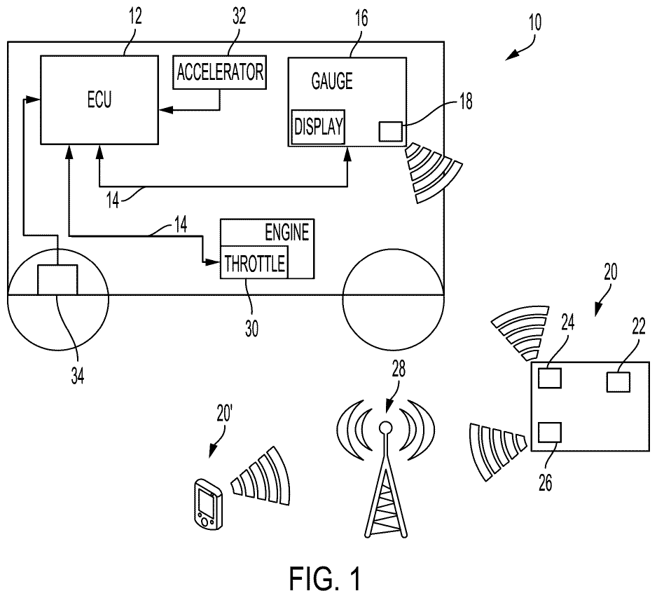

The group ride range monitoring system may provide a comprehensive solution for managing and coordinating group rides of recreational vehicles. In some cases, the system may utilize a vehicle control system 10 as shown in FIG. 1.

The vehicle control system 10 may include an ECU (Electronic Control Unit) 12 connected to various components via a controller area network (CAN) 14. In some cases, a gauge 16 may be connected to the CAN 14 to display information to the driver.

A wireless communication module 18 may enable communication with external devices. In some implementations, the wireless communication module 18 may communicate with a first handheld wireless device (e.g., smartphone) 20 and a second handheld wireless device (e.g., smartphone) 20′.

The vehicle control system 10 may also include a GPS module 22 for location tracking. In some cases, a local wireless communication module 24 and a distance wireless communication module 26 may facilitate short-range and long-range wireless communication, respectively. Cellular communication systems (e.g., antennae) 28 may enable connection to cellular networks for extended communication range.

The vehicle control system 10 may interface with various vehicle components. In some implementations, a throttle 30 and an accelerator 32 may be connected to the ECU 12 for vehicle speed control. A wheel speed sensor 34 may provide input to the ECU 12 about the vehicle's speed.

By integrating these components, the group ride range monitoring system may collect and analyze data from multiple vehicles, determine range limitations, and communicate this information to all participants in a group ride. This may enable riders to make informed decisions about route planning, fuel stops, and overall ride management.

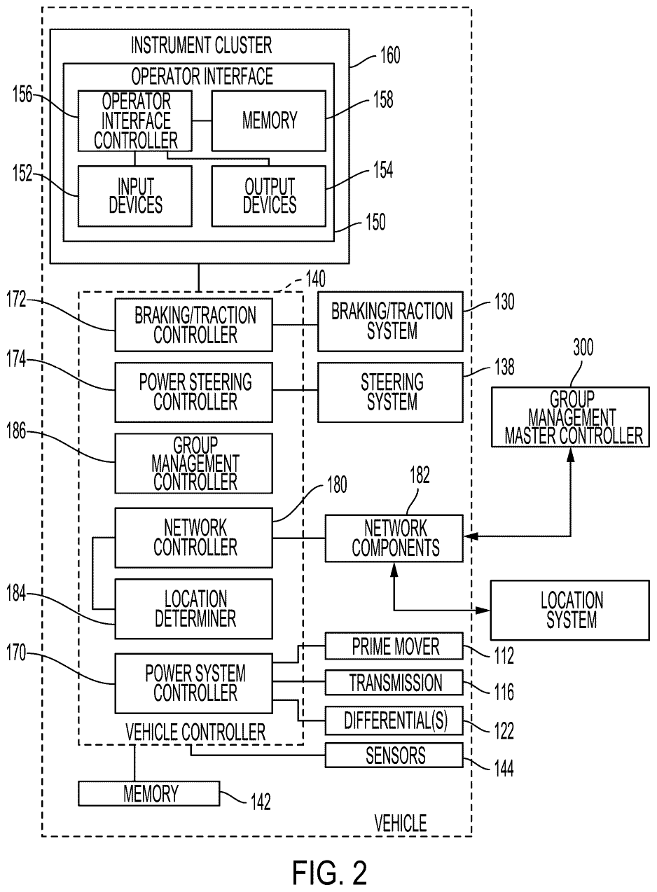

In some cases, the vehicle control system 10 may have the architecture as illustrated in FIG. 2. The vehicle control system 10 may comprise an instrument cluster 160 that includes an operator interface 150. The operator interface 150 may include an operator interface controller 156, memory 158, input devices 152, and output devices 154. These components may work together to facilitate interaction between a vehicle operator and the vehicle control system 10.

A communication bus 140 may connect the instrument cluster 160 to other system components. In some implementations, a braking/traction system 130 and a steering system 138 may be controlled by their respective controllers: a braking/traction controller 172 and a power steering controller 174.

The vehicle control system 10 may also include a group management controller 186, which may be connected to a network controller 180. The network controller 180 may interface with network components 182, which in turn may communicate with a group management master controller 300 located outside the main vehicle structure.

A location determiner 184 may be included in the vehicle control system 10, providing positional information. The power system of the vehicle may be managed by a power system controller 170, which may be connected to a prime mover 112, a transmission 116, and differentials 122.

Sensors 144 may be integrated into the vehicle control system 10, providing various data inputs. The entire system may be supported by vehicle memory 142, which may store necessary data and instructions.

In some cases, the communication bus 140 may serve as a central pathway for data exchange between different components of the vehicle control system 10. This may allow for efficient coordination between various subsystems and controllers.

The vehicle control system 10 may integrate multiple functions including operator interface, vehicle dynamics control, power management, location determination, and group management capabilities. This integration may allow for comprehensive monitoring and management of group rides, taking into account various factors that may affect vehicle range and performance.

The operator interface 150 may provide a means for the vehicle operator to interact with the vehicle control system 10. In some implementations, the input devices 152 may include buttons, switches, or touch-sensitive surfaces, while the output devices 154 may include displays, speakers, or haptic feedback devices.

The group management controller 186 may play a crucial role in coordinating group rides. This controller may process information from individual vehicles and communicate with the group management master controller 300 to facilitate group-wide decision making and alerts.

The network components 182 may include various communication technologies such as the wireless communication module 18, the GPS module 22, the local wireless communication module 24, and the distance wireless communication module 26. These components may enable the vehicle to communicate with other vehicles in the group as well as with external systems.

In some cases, the vehicle control system 10 may utilize the controller area network (CAN) 14 as part of the communication bus 140 to facilitate data exchange between various components such as the ECU 12, the gauge 16, the throttle 30, the accelerator 32, and the wheel speed sensor 34.

The system architecture may allow for comprehensive monitoring and management of group rides, enabling features such as range limitation analysis, group-wide alerts, and adaptive route planning based on the capabilities and status of all vehicles in the group.

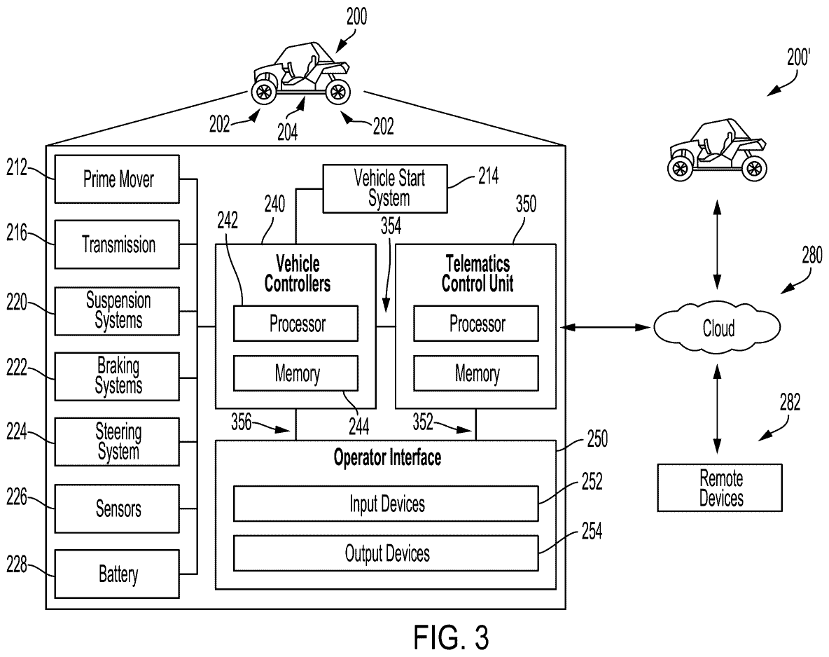

In some cases, the group ride range monitoring system may integrate with individual vehicles through a vehicle control system 10 as illustrated in FIG. 3. The vehicle control system 10 may be implemented in a vehicle 200 that includes ground engaging members 202 and a frame 204.

The vehicle control system 10 may include several subsystems, including a prime mover 212, a vehicle start system 214, the transmission 216, suspension systems 220, braking systems 222, the steering system 224, sensors 226, and a battery 228. These components may be interconnected and controlled by a vehicle controller 240.

The vehicle controller 240 may include a processor 242 and memory 244. In some cases, the vehicle controller 240 may interface with various vehicle systems and manage overall vehicle operation. Connected to the vehicle controller 240 may be a telematics control unit 350, which may also contain a processor and a connection 352. The telematics control unit 350 may handle communication functions and data processing related to telematics.

An operator interface 250 may be included in the vehicle control system 10. The operator interface 250 may include input devices 252 and output devices 254. This interface may allow the operator to interact with the vehicle's systems and receive information.

The vehicle control system 10 may feature the network controller 280, which may facilitate communication with external network components 282. This may include a connection to a cloud system and remote devices, enabling data exchange and remote monitoring or control capabilities.

A communication link 354 may connect the vehicle controller 240 and the telematics control unit 350, allowing for data exchange between these two central components. A connection 356 may also be provided, offering additional connectivity options.

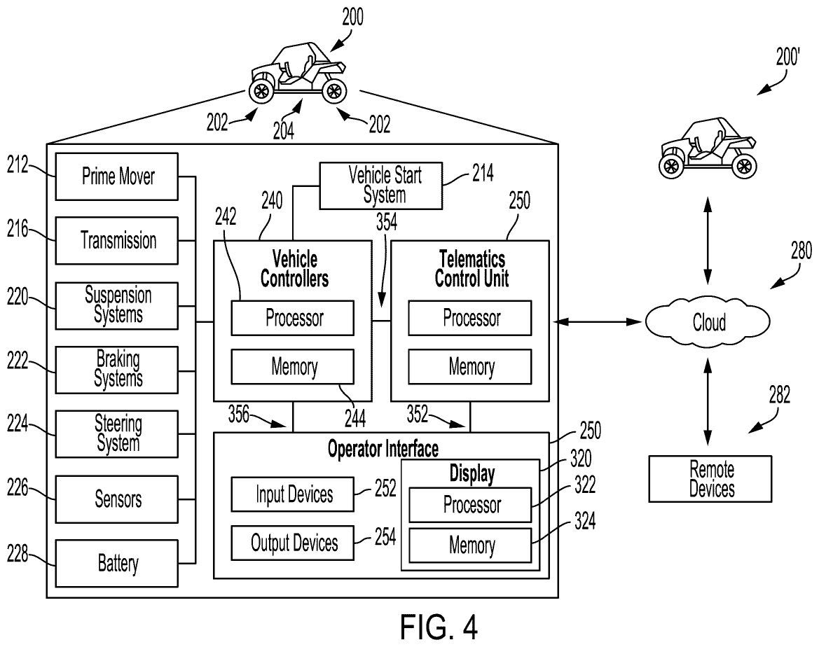

FIG. 4 illustrates a similar configuration of the vehicle control system 10, with the addition of a display 320. The display 320 may include a display processor 322 and display memory 324. This display 320 may be part of the operator interface 250, providing visual information to the vehicle operator.

In some cases, the vehicle control system 10 may utilize the wireless communication module 18, the GPS module 22, the local wireless communication module 24, and the distance wireless communication module 26 to facilitate communication between vehicles participating in a group ride. These components may enable the sharing of status data, including fuel levels, battery charge, diagnostic information, and location data.

The telematics control unit 350 may play a crucial role in facilitating inter-vehicle communication. In some implementations, the telematics control unit 350 may use cellular communication systems or cloud 280 to transmit and receive data over long distances, allowing vehicles to stay connected even when spread out over a large area.

The vehicle controller 240 may analyze the status data collected from various vehicle systems and sensors 226. The analysis may include determining the vehicle's current range based on factors such as fuel level, battery charge, and terrain conditions. The vehicle controller 240 may then transmit this range information to other vehicles in the group ride through the telematics control unit 350.

In some cases, the display 320 may present information about the group ride, including the locations and status of other vehicles, through a graphical user interface. The interface may be updated in real-time as new information is received from other vehicles in the group.

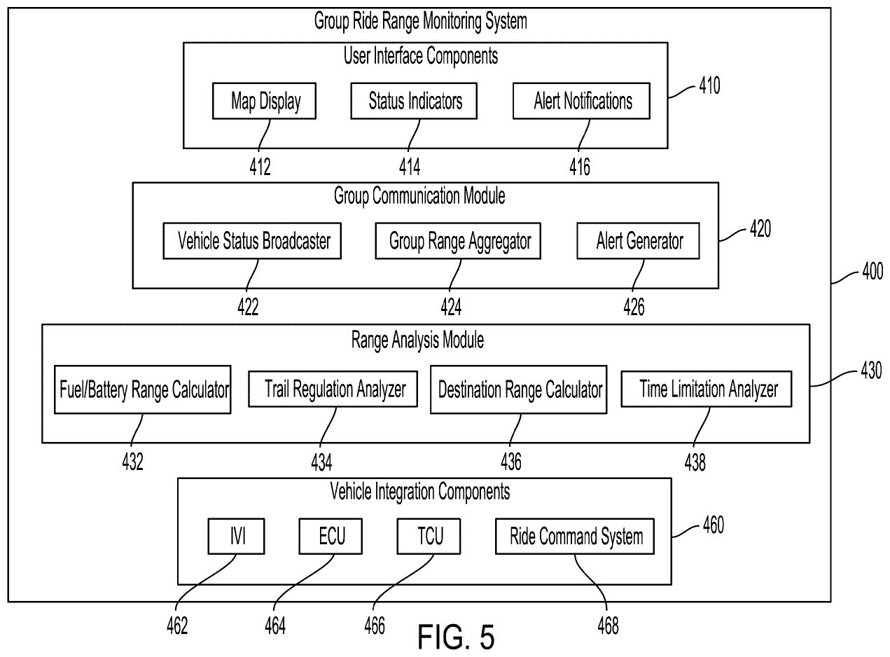

The integration of these vehicle-specific components with the overall group ride range monitoring system may allow for comprehensive monitoring and management of group rides, taking into account the individual capabilities and limitations of each participating vehicle. FIGS. 5-8 show different aspects and components of the group ride range monitoring system. These figures may share some common components and modules, illustrating how they interact within the larger system architecture. The figures represent different aspects of the group ride range monitoring system, encompassing both vehicle-specific components and larger system elements. FIG. 5 provides an overview of the monitoring system 400.

FIG. 5 offers a high-level architectural perspective, presenting the system as a collection of interconnected modules. This view emphasizes the overall structure and main functional areas of the system, showing how different components like interface, communication, analysis, and vehicle integration work together. FIG. 5 primarily depicts the overall system architecture, including both in-vehicle components (like the vehicle integration components 460) and broader system modules (such as the interface components 410 and analysis module 430). The figure represents a hybrid view, showing how vehicle-specific elements integrate with the larger monitoring system.

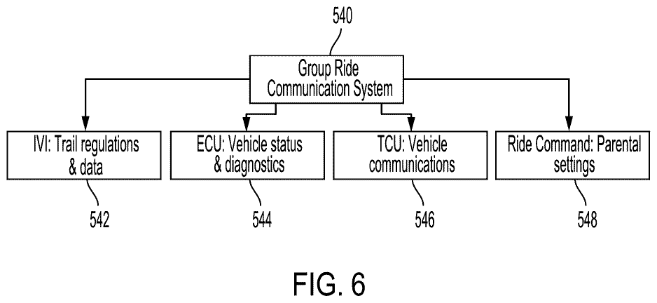

FIG. 6 focuses on the group ride communication system 540, which is a part of the overall monitoring system. FIG. 6 focuses more on the communication aspects, particularly the group ride communication system 540. While this includes vehicle-specific modules like the IVI 542 and ECU 544, it also represents how these components interact within a larger communication framework that extends beyond individual vehicles. FIG. 6 shifts the focus to the communication aspect of the system, highlighting the group ride communication system's role in facilitating data exchange between vehicles and various vehicle subsystems. The perspective emphasizes the importance of real-time information sharing in managing group rides effectively.

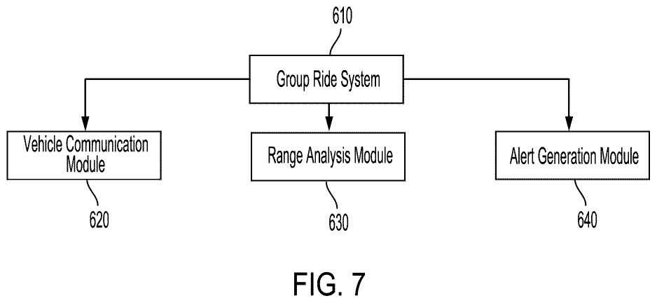

FIG. 7 illustrates the group ride system 610, which coordinates functions across multiple vehicles. The figure represents more of the larger system perspective, showing how vehicle-specific data (collected through the vehicle communication module 620) is analyzed and utilized at a group level. FIG. 7 provides a functional perspective, centering on the group ride system and how it coordinates with other modules to analyze range, generate alerts, and manage vehicle communications. This view illustrates the system's decision-making and coordination capabilities.

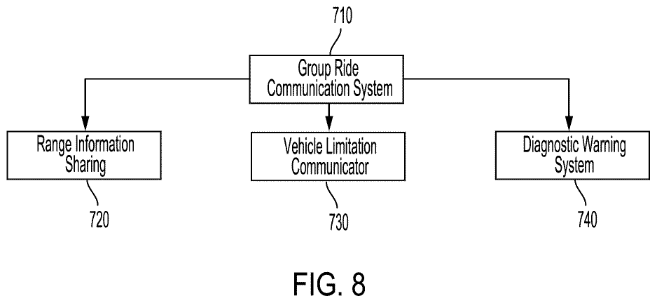

FIG. 8 depicts the communication system 710, which is primarily part of the larger system rather than being vehicle-specific. The figure shows how information is shared and processed across the entire group ride, emphasizing the system-wide nature of the communication and warning functionalities. FIG. 8 offers a data flow perspective, showing how information is shared, limitations are communicated, and warnings are generated within the system. This context emphasizes the importance of timely and accurate information dissemination in managing group rides.

These varied perspectives allow for a more complete understanding of the system's operation, from its overall architecture to specific functional areas and data flows. By presenting the system from different angles, the figures collectively demonstrate how various components interact to monitor range, analyze data, generate alerts, and facilitate communication, all contributing to the safe and efficient management of group rides. The recurring presence of components related to communication, data analysis, and alert generation across these figures demonstrates the interconnected nature of the system. Each figure provides a different perspective on how these components work together to monitor and manage group rides, ensuring that all vehicles remain within their operational limits and reach their destination safely.

In summary, these figures progressively move from a hybrid vehicle-system view (FIG. 5) to a more system-wide perspective (FIG. 8), illustrating how vehicle-specific components integrate and contribute to the larger group ride monitoring system. This multi-layered representation helps to explain how individual vehicle data and capabilities are leveraged within the broader context of group ride management and safety.

In some cases, the group ride range monitoring system may include a monitoring system 400 as illustrated in FIG. 5. The monitoring system 400 may comprise several interconnected components designed to monitor and manage group rides.

The monitoring system 400 may include interface components 410. In some implementations, the interface components 410 may consist of a map display 412, status indicators 414, and alert notifications 416. The map display 412 may provide visual information to users about the locations of vehicles participating in the group ride. The status indicators 414 may present information about the status of each vehicle, such as fuel levels or battery charge. The alert notifications 416 may display important messages or warnings to riders.

The interface components 410 may include various elements designed to provide users with essential information and controls for the group ride monitoring system. These components may include visual displays, input mechanisms, and notification systems that allow riders to interact with the system and stay informed about the group's status. Key interface components may include a map display, status indicators, alert notifications, input controls, data panels, and communication tools. A map display may include dynamic visual representation of the group ride, showing the locations of all participating vehicles, planned routes, and relevant points of interest. The display may use color-coding or icons to indicate the status of each vehicle. Status indicators may include visual cues that provide at-a-glance information about critical factors such as fuel levels, battery charge, vehicle health, and proximity to geographical boundaries. The indicators may use colors, symbols, or numerical values to quickly convey information. Alert notifications may include prominent visual and/or audible signals designed to draw attention to important messages or warnings. The notifications may include low fuel alerts, approaching range limitations, or notifications about changes in group status. Input controls may include touch-sensitive areas, buttons, or voice command systems that allow users to interact with the monitoring system, adjust settings, or respond to alerts. Data panels may include dedicated areas of the interface that display detailed information about individual vehicles or the group as a whole, such as range calculations, estimated time of arrival, or trail difficulty ratings. Communication tools may include features that enable messaging or voice communication between group members, facilitating coordination and information sharing during the ride. By integrating these interface components, the group ride monitoring system can provide a comprehensive and user-friendly experience, enabling riders to stay informed and make timely decisions throughout the group ride.

The map display may provide a visual representation of the group ride's current status and location information. The map display may show the positions of all vehicles participating in the group ride, typically represented by icons or markers on a topographical or street map. The map display may also include route information, such as the planned path for the group ride, upcoming waypoints, or points of interest.

In some implementations, the map display may use color-coding or other visual indicators to represent the range status of each vehicle. For example, vehicles with ample range may be shown in green, while those approaching their range limitations could be displayed in yellow or red. The map display may also include overlays showing geographical boundaries, trail regulations, or other relevant information that could affect the group's travel plans.

The map display may be interactive, allowing users to zoom in or out, pan across different areas, or tap on individual vehicle icons to view more detailed information about each participant. The map display may also update in real-time as vehicles move or their status changes, providing a dynamic and current view of the group ride's progress and overall situation.

The status indicators may provide visual representations of various vehicle parameters and conditions relevant to the group ride. These indicators could include fuel level or battery charge percentage for each vehicle, estimated remaining range based on current conditions, vehicle health status (e.g., engine temperature or tire pressure), proximity to geographical boundaries or restricted areas, compliance with trail regulations (e.g., width, weight, or difficulty ratings), time remaining until scheduled stops or destination arrival, connectivity status between vehicles in the group, etc.

The status indicators may use color coding, icons, or numerical values to quickly convey information to riders. For example, a green icon might indicate normal status, while yellow or red icons could signify approaching limitations or critical issues. These visual cues allow riders to quickly assess the overall group status and identify any potential concerns that may require attention or adjustments to the ride plan.

The alert notifications may display important messages or warnings to riders participating in the group ride. These notifications can include a variety of critical information such as low fuel or battery warnings for individual vehicles, approaching range limitations for the group, deviations from the planned route, upcoming terrain or trail difficulties, weather alerts that may affect the ride, mechanical issues detected in any group vehicle, separation alerts if a vehicle falls too far behind or moves too far ahead of the group, reminders for scheduled stops or waypoints, emergency notifications for immediate attention, etc.

The alert notifications may be displayed prominently on the vehicle's interface, potentially using color-coding (e.g., yellow for caution, red for critical) or distinctive icons to quickly convey the urgency of the message. These alerts may also be accompanied by audible signals to ensure riders do not miss important information. In some implementations, the alerts may be customizable, allowing riders or group leaders to set preferences for which types of notifications they receive and how they are displayed.

A communication module 420 may be included in the monitoring system 400. The communication module 420 may comprise a status broadcaster 422, a range aggregator 424, and an alert generator 426. The status broadcaster 422 may transmit vehicle status information to other vehicles in the group. The range aggregator 424 may collect and compile range information from all vehicles in the group. The alert generator 426 may create alerts based on the collected data and predefined criteria.

The communication module may comprise hardware and software components configured to facilitate data exchange between vehicles participating in the group ride. The module may utilize various wireless communication technologies such as Bluetooth, Wi-Fi, cellular networks, or satellite communication to ensure reliable connectivity even in remote areas. The communication module may be responsible for transmitting and receiving status data, including fuel levels, battery charge, diagnostic information, and GPS coordinates. It may also handle the broadcasting of alerts and notifications to all group members. The module may be designed to operate in both short-range and long-range scenarios, adapting to the specific needs of the group ride. Additionally, the communication module may interface with external data sources to gather relevant information such as weather updates, trail conditions, or traffic reports that could impact the group's travel plans.

The communication module can be implemented as part of the vehicle's onboard systems or as an offsite component, depending on the specific architecture of the group ride range monitoring system. In a vehicle-integrated implementation, the communication module may be part of the vehicle's telematics control unit (TCU) or integrated into the in-vehicle infotainment (IVI) system. This allows for direct access to vehicle sensors and systems, enabling real-time collection and transmission of status data.

Alternatively, the communication module can be implemented as an offsite component, such as part of a cloud-based service or centralized server. In this configuration, vehicles would transmit data to the offsite communication module, which would then process and redistribute information to all group members. This approach can offer advantages in terms of processing power and the ability to integrate with external data sources more easily.

A hybrid approach is also possible, where some communication functions are handled by onboard vehicle systems, while others are managed by an offsite component. This configuration can provide redundancy and flexibility, allowing the system to adapt to varying connectivity conditions encountered during group rides.

Regardless of its physical location, the communication module plays a crucial role in facilitating data exchange between vehicles and ensuring that all participants in the group ride have access to up-to-date information about the group's status, range limitations, and potential hazards. The module's ability to operate in both short-range and long-range scenarios, as well as its capacity to interface with external data sources, makes it a versatile component in managing the complexities of group rides across diverse terrains and conditions.

The status broadcaster may be a component of the communication module 420 responsible for transmitting vehicle status information to other vehicles participating in the group ride. The component may collect relevant data from various vehicle systems, such as fuel levels, battery charge, GPS coordinates, and diagnostic information, and package it for transmission. The status broadcaster may utilize various wireless communication technologies, such as Bluetooth, Wi-Fi, or cellular networks, to ensure that status updates are regularly shared with all group members. The continuous sharing of status information allows the group ride monitoring system to maintain an up-to-date understanding of each vehicle's condition and capabilities, enabling real-time adjustments to the group's travel plans and facilitating prompt responses to any emerging issues or limitations.

The range aggregator may be a component of the communication module responsible for collecting and compiling range information from all vehicles participating in the group ride. The range aggregator may receive range data from individual vehicles, including factors such as fuel levels, battery charge, and estimated range based on current conditions and terrain. The range aggregator may process this information to create a comprehensive overview of the group's range capabilities. The range aggregator may also factor in additional constraints such as trail regulations, vehicle specifications, and geographical boundaries to provide a more accurate assessment of the group's overall range. By consolidating range data from all participants, the range aggregator enables the system to make informed decisions about route planning, identify potential issues before they become critical, and ensure that the group ride remains within safe operational parameters for all vehicles involved.

The alert generator may be a component of the communication module responsible for creating and issuing alerts based on the analyzed data and predefined criteria. The component may participate in monitoring various parameters such as fuel levels, battery charge, vehicle diagnostics, and proximity to geographical boundaries or trail limitations. When these parameters approach or exceed predetermined thresholds, the alert generator may create appropriate warnings or notifications.

The alert generator may produce different types of alerts depending on the severity and nature of the detected issue. For example, it may generate low-priority notifications for approaching fuel stops or battery charging points, medium-priority alerts for vehicles nearing their range limits, and high-priority warnings for critical mechanical issues or imminent geographical boundary violations.

These alerts may be formatted in a standardized manner to ensure clear and consistent communication across all vehicles in the group ride. The alert generator may also prioritize and manage multiple alerts to prevent information overload for riders, ensuring that the most critical information is prominently displayed and acted upon.

Once generated, these alerts may be transmitted to the status broadcaster for distribution to all vehicles in the group ride, ensuring that all participants are aware of potential issues or limitations affecting the group's travel plans. The alert generator thus plays a crucial role in maintaining group safety and cohesion during the ride by proactively identifying and communicating potential challenges or risks.

The monitoring system 400 may also incorporate an analysis module 430. The analysis module 430 may contain a range calculator 432, a regulation analyzer 434, a destination calculator 436, and a limitation analyzer 438. The range calculator 432 may determine the range capabilities of individual vehicles and the group as a whole. The regulation analyzer 434 may evaluate trail regulations and vehicle compatibility. The destination calculator 436 may assess whether planned destinations are within the group's range capabilities. The limitation analyzer 438 may identify and analyze various limitations that may affect the group ride.

The range calculator 432 may be a component of the analysis module 430 responsible for determining the range capabilities of individual vehicles and the group as a whole. The component may utilize various inputs such as fuel levels, battery charge states, vehicle specifications, terrain data, and historical performance metrics to calculate the estimated range for each vehicle under current conditions.

The range calculator 432 may employ algorithms that take into account factors such as current fuel level or battery charge, fuel efficiency or energy consumption rates, terrain elevation changes along the planned route, weather conditions affecting vehicle performance, vehicle load and passenger weight, tire pressure and rolling resistance, and historical data on similar routes or conditions. By considering these factors, the range calculator 432 can provide a more accurate estimation of each vehicle's range capabilities. The information can be used to determine the group's overall range limitation, which is typically based on the vehicle with the most constrained range.

The range calculator 432 may continuously update its calculations throughout the group ride, adjusting estimates based on real-time data such as actual fuel consumption rates, changes in terrain, or unexpected weather conditions. This dynamic approach allows for more precise range management and helps prevent situations where a vehicle might unexpectedly run out of fuel or battery charge.

Additionally, the range calculator 432 may interface with other components of the group ride range monitoring system, such as the regulation analyzer and the destination calculator 436, to ensure that range calculations take into account trail regulations and planned destinations. This integration allows for a comprehensive assessment of the group's ability to complete the planned route safely and efficiently.

The range calculator 432 may employ algorithms that take into account factors such as current fuel level or battery charge, fuel efficiency or energy consumption rates, terrain elevation changes along the planned route, weather conditions affecting vehicle performance, vehicle load and passenger weight, tire pressure and rolling resistance, and historical data on similar routes or conditions. The algorithms may utilize mathematical models and data analysis techniques to process the various inputs and calculate accurate range estimations. For example, the algorithms may incorporate machine learning models trained on historical ride data to predict energy consumption based on route characteristics and driving patterns. They may also use real-time data processing to continuously update range calculations as conditions change during the ride. The algorithms may account for interdependencies between different factors, such as how terrain and weather affect fuel efficiency, to provide more precise range estimates. Additionally, the algorithms may employ predictive analytics to anticipate potential range issues before they become critical, allowing for proactive route adjustments or refueling stops.

The regulation analyzer 434 may be a component of the analysis module 430 responsible for evaluating trail regulations and assessing vehicle compatibility with those regulations. This component may process information about trail characteristics, such as width restrictions, difficulty ratings, and vehicle size limitations, and compare them against the specifications of the vehicles participating in the group ride.

The regulation analyzer 434 may utilize data from various sources, including trail databases containing information on trail specifications and regulations, vehicle specification data provided by the ECU or stored in the vehicle's system, and real-time trail condition updates from external sources or other group members. By analyzing this data, the regulation analyzer 434 can determine whether each vehicle in the group is suitable for the planned route and may identify potential issues such as vehicles that are too wide for narrow trail sections, vehicles lacking the necessary capabilities for difficult terrain, and restrictions on certain vehicle types for specific trails.

The regulation analyzer 434 may work in conjunction with other components of the group ride range monitoring system, such as the range calculator 432 and the destination calculator 436, to ensure that the planned route is not only within the group's range capabilities but also compliant with all relevant trail regulations. The comprehensive analysis helps prevent situations where the group might encounter impassable sections or regulatory restrictions during their ride.

In cases where potential conflicts are identified, the regulation analyzer 434 may generate alerts or suggestions for alternative routes that accommodate all vehicles in the group. This proactive approach to route planning enhances safety and ensures a smoother, more enjoyable experience for all participants in the group ride.

The destination calculator 436 may be a component of the analysis module 430 responsible for assessing whether planned destinations are within the group's range capabilities. This component may utilize data from the range calculator 432 and regulation analyzer 434 to determine if the group can safely reach a specified destination given their current range limitations and trail regulations.

The destination calculator 436 may perform the following operations: receive destination input (e.g., accept destination coordinates or predefined waypoints for the group ride), calculate total distance (e.g., determine the total distance that needs to be covered using the current location of the group and the specified destination), assess terrain and trail conditions (e.g., consider elevation changes, trail difficulty, and any known obstacles along the route that could affect range consumption), compare with group range (e.g., compare the calculated distance and estimated energy consumption with the group range limitation determined by the range calculator 432), consider refueling/recharging options (e.g., If the destination is beyond the current group range, it may identify potential refueling or recharging stops along the route), generate feasibility assessment (e.g., Based on its calculations, the destination calculator 436 may provide a yes/no determination on whether the destination is reachable, along with an estimated margin of safety, suggest alternatives (e.g., If the original destination is deemed unreachable, it may propose alternative destinations within the group's range capabilities), etc. By integrating with other components of the group ride range monitoring system, the destination calculator 436 helps ensure that ride plans are realistic and achievable for all participants, reducing the risk of vehicles becoming stranded due to range limitations.

The limitation analyzer 438 may be a component of the analysis module 430 responsible for identifying and analyzing various limitations that may affect the group ride. The component may process data from multiple sources to determine potential constraints on the group's travel capabilities. The limitation analyzer 438 may consider factors such as vehicle-specific limitations (e.g., fuel capacity, battery range, engine performance, and physical dimensions that may restrict access to certain trails or areas), environmental constraints (e.g., terrain difficulty, elevation changes, and weather conditions that could impact vehicle performance or rider safety), regulatory restrictions (e.g., trail regulations, vehicle type restrictions, and speed limits applicable to specific areas or routes), time-based limitations (e.g., daylight hours, park operating times, rider-imposed time constraints), group dynamics (e.g., considering the skill levels and preferences of all riders in the group), parent-imposed constraints (e.g., time constraints, distance constraints), etc.

The limitation analyzer 438 may integrate data from the range calculator, regulation analyzer 434, and other system components to provide a comprehensive assessment of potential limitations. The limitation analyzer 438 may use algorithms to weigh the impact of various factors and identify which limitations are most likely to affect the group ride. The results from the limitation analyzer 438 may be used to inform route planning, generate alerts, and guide decision-making throughout the group ride to ensure a safe and enjoyable experience for all participants.

In some cases, the monitoring system 400 may include vehicle integration components 460. The vehicle integration components 460 may comprise an IVI (In-Vehicle Infotainment system) 462, an ECU (Engine Control Unit) 464, a TCU (Telematics Control Unit) 466, and a RIDE Command system 468. These components may integrate the monitoring system 400 with the vehicle's existing systems and controls.

The IVI 462 may provide a user interface for the vehicle operator to interact with the monitoring system 400. The ECU 464 may manage the vehicle's engine and related systems, providing crucial data for range calculations. The TCU 466 may handle communication between vehicles and with external systems. The RIDE Command system 468 may coordinate various aspects of the group ride, including navigation and ride planning.

The IVI 462 may serve as an interface between the vehicle's systems and the rider. IVI 462 may include a display screen and input controls integrated into the vehicle's dashboard or console. The IVI 462 may present critical information to the rider, such as vehicle status, group ride data, and alerts, in a clear and easily understandable format. IVI 462 may also receive and handle user inputs for adjusting settings or responding to notifications. In the context of group rides, the IVI 462 may display real-time updates on group range limitations, individual vehicle statuses, and any alerts or warnings generated by the system. The IVI 462 may also integrate with other vehicle systems, such as the ECU 464 and TCU 466, to gather and process data necessary for effective group ride management. Additionally, the IVI 462 may provide access to navigation features, communication tools for interacting with other group members, and customizable display options to suit individual rider preferences.

The ECU 464 may be part of the vehicle control system. The ECU 464 can manage and control various aspects of the engine's operation. In the context of the group ride range monitoring system, the ECU 464 may collect and provide essential data that affects vehicle range and performance.

The ECU 464 can continuously monitor and process information from multiple sensors throughout the vehicle, including fuel level sensors, battery charge sensors, and various engine performance sensors. The data can be used to calculate important parameters such as fuel consumption rates, engine efficiency, and overall vehicle range.

In the group ride scenario, the ECU 464 can communicate the information to other components of the system, particularly the vehicle communication module and the range analysis module. By providing real-time data on fuel levels, battery charge (for electric or hybrid vehicles), and engine performance, the ECU 464 enables accurate calculation of individual vehicle range and contributes to determining the overall group range limitation.

Additionally, the ECU 464 may detect and report diagnostic trouble codes (DTCs) that could potentially affect a vehicle's range or performance during the group ride. The information can help identify potential issues early and allow the system to generate appropriate alerts or adjust the group ride plan accordingly.

The ECU's integration with the group ride range monitoring system helps ensure that each vehicle's current operational status is accurately represented in the overall group assessment, contributing to safer and more efficient group rides.

The TCU 466 may serve as the central hub for vehicle-to-vehicle and vehicle-to-infrastructure communications. The TCU 466 can collect and process data from various vehicle systems, including the engine, transmission, and onboard sensors, and transmits the information to other vehicles in the group or to a central management system.

In the group ride range monitoring system, the TCU 466 plays a vital role in sharing real-time status data such as fuel levels, battery charge, vehicle location, and diagnostic information with other vehicles in the group. This continuous data exchange enables the system to maintain an up-to-date understanding of each vehicle's capabilities and limitations, which is crucial for determining the overall group range and generating timely alerts.

The TCU 466 also facilitates the reception of external data, such as weather updates, trail conditions, and traffic information, which can be integrated into the group ride management system to enhance route planning and safety. Additionally, the TCU 466 may handle communication with mobile devices, allowing riders without built-in vehicle displays to participate in the group ride monitoring system through smartphone applications.

In some implementations, the monitoring system 400 may interface with the vehicle control system 10 through the communication bus 140. This may allow the monitoring system 400 to access data from various vehicle systems and sensors 226, enhancing the accuracy of range calculations and status updates.

The monitoring system 400 may utilize the wireless communication module 18, the GPS module 22, the local wireless communication module 24, and the distance wireless communication module 26 to facilitate communication between vehicles participating in a group ride. These components may enable the sharing of status data, including fuel levels, battery charge, diagnostic information, and location data.

In some cases, the monitoring system 400 may display information through the display 320, providing riders with real-time updates on group status, range limitations, and alerts. The operator interface 250 may allow riders to interact with the monitoring system 400, adjusting settings or responding to alerts as needed.

The monitoring system 400 may work in conjunction with the group management controller 186 and the group management master controller 300 to coordinate group-wide decisions and alerts based on the analyzed data from all participating vehicles.

The group ride range monitoring system can be implemented in various configurations, depending on the specific requirements and infrastructure available. It can be part of each vehicle, integrated into a remote system, or a combination of both.

When implemented as part of each vehicle, the monitoring system 400 may be integrated into the vehicle's existing control systems, such as the vehicle control system 10 described earlier. In this configuration, each vehicle would have its own instance of the monitoring system 400, allowing for distributed processing and real-time analysis of local vehicle data.

Alternatively, the monitoring system 400 can be implemented as a remote system, possibly hosted on a cloud-based platform or a centralized server. In this case, the vehicles would transmit their status data to the remote system, which would then perform the analysis and send back relevant information and alerts to all vehicles in the group.

A hybrid approach is also possible, where some components of the monitoring system 400 are implemented within each vehicle, while others are part of a remote system. For example, the interface components 410 and vehicle integration components 460 might be implemented locally in each vehicle, while the communication module 420 and analysis module 430 could be part of a remote system.

The choice between these configurations depends on factors such as the available communication infrastructure, the processing capabilities of the vehicles, and the desired level of autonomy for each vehicle in the group. Regardless of the specific implementation, the goal remains to provide comprehensive monitoring and management of group rides, ensuring safety and efficiency for all participants.

In some cases, the group ride range monitoring system may include a group ride communication system 540 for managing group ride communications as illustrated in FIG. 6.

The group ride communication system 540 may serve as a central component for managing and coordinating communications between vehicles participating in a group ride. This system may integrate with various vehicle modules and external data sources to facilitate real-time information sharing and decision-making during group rides.

The group ride communication system 540 may utilize a combination of short-range and long-range communication technologies to ensure reliable data exchange between vehicles, even in areas with limited cellular coverage. This may include technologies such as Bluetooth, Wi-Fi Direct, radio communication systems, and satellite communication systems.

In addition to facilitating vehicle-to-vehicle communication, the group ride communication system 540 may also interface with external data sources to gather relevant information for the group ride. This could include weather updates, trail condition reports, and real-time traffic information, all of which may be crucial for safe and efficient group navigation.

The system may also incorporate adaptive algorithms to process and analyze incoming data from multiple sources, allowing it to make intelligent decisions about route planning, range management, and safety alerts. This may enable the system to proactively identify potential issues and suggest appropriate actions to the group leader or individual riders.

Furthermore, the group ride communication system 540 may be designed with scalability in mind, capable of handling varying group sizes and accommodating different types of recreational vehicles. This flexibility may allow the system to be used effectively for small family outings as well as larger organized events.

The communication system 540 may be connected to an IVI module 542, an ECU module 544, a TCU module 546, and a RIDE Command module 548. These connections may allow for data exchange and coordination between different aspects of the group ride monitoring system.

The IVI module 542 may handle trail regulations and related data for the group ride. In some implementations, the IVI module 542 may interface with the map display 412 to present trail information to riders.

The IVI module 542 as part of the group ride communication system may serve as an interface between the vehicle's systems and the riders. As part of the group ride communication system 540, the IVI module 542 may process and display trail regulations and related data to the riders. The information may include trail width restrictions, vehicle size limitations, and difficulty ratings that may affect the group's ability to navigate certain routes.

The IVI module 542 can integrate with the map display to present this trail information in a clear and easily understandable format. The IVI module 542 may overlay trail regulation data onto the map, highlighting areas where certain vehicles in the group may face restrictions or challenges. The visual representation can help riders make informed decisions about route planning and potential detours.

Additionally, the IVI module 542 in the group ride communication context may act as a central hub for receiving and displaying real-time updates about the group's status. The IVI module 542 may show the current group range limitation, individual vehicle statuses, and any alerts or warnings generated by the system. By presenting this information through the vehicle's display, the IVI module 542 ensures that riders have immediate access to critical data that may affect the group's travel plans.

The IVI module 542 may also facilitate user input, allowing riders to interact with the group ride communication system. This may include adjusting settings, acknowledging alerts, or inputting new destination information. By serving as both an output and input device, the IVI module 542 enables seamless communication between the riders and the broader group ride monitoring system.

The ECU module 544 may be responsible for monitoring and reporting vehicle status and diagnostic information. The ECU module 544 may communicate with the ECU 12 to gather data on vehicle performance and operating parameters.

The ECU module 544 as part of the group ride communication system 540 may play a role in monitoring and reporting vehicle status and diagnostic information. In the context of group rides, the ECU module 544 may interface with the vehicle's engine management system to gather real-time data on various operating parameters that can affect the vehicle's range and performance during the ride.

The ECU module 544 may continuously collect and process data from multiple sensors throughout the vehicle, including fuel level sensors, battery charge sensors (for electric or hybrid vehicles), engine temperature sensors, and various performance metrics. The data may be used to calculate important parameters such as fuel consumption rates, engine efficiency, and overall vehicle range.

In the group ride scenario, the ECU module 544 may communicates this information to other components of the system, particularly the vehicle communication module 620 and the range analysis module 630. By providing real-time data on fuel levels, battery charge, and engine performance, the ECU module 544 enables accurate calculation of individual vehicle range and contributes to determining the overall group range limitation.

Additionally, the ECU module 544 may detect and report diagnostic trouble codes (DTCs) that could potentially affect a vehicle's range or performance during the group ride. This information can help identify potential issues early and allow the system to generate appropriate alerts or adjust the group ride plan accordingly.

The integration of the ECU module 544 with the group ride communication system 540 ensures that each vehicle's current operational status is accurately represented in the overall group assessment. This real-time data exchange contributes to safer and more efficient group rides by allowing for proactive management of vehicle limitations and potential issues.

The TCU module 546 may manage vehicle-to-vehicle and vehicle-to-infrastructure communications. In some cases, the TCU module 546 may utilize the wireless communication module 18, the local wireless communication module 24, and the distance wireless communication module 26 to facilitate data exchange between vehicles in the group ride.

The TCU module 546 as part of the group ride communication system 540 may play a role in facilitating vehicle-to-vehicle and vehicle-to-infrastructure communications. In the context of group rides, the TCU module 546 may serve as a central hub for collecting, processing, and transmitting data between vehicles and external systems.

The TCU module 546 may utilize various wireless communication technologies, including cellular networks, satellite communication, and short-range protocols like Bluetooth or Wi-Fi. This versatility allows the module to maintain connectivity even in areas with limited cellular coverage, ensuring continuous communication throughout the group ride.

As part of the group ride communication system 540, the TCU module 546 may perform the following functions. In performing data collection and transmission, the TCU module 546 gathers real-time data from various vehicle systems, including fuel levels, battery charge, GPS location, and diagnostic information. The TCU module 546 can then transmit this data to other vehicles in the group and potentially to a central management system. In performing range and status updates, the TCU module 546 may continuously update and share information about the vehicle's current range and status, allowing the group ride system to calculate and adjust the overall group range limitation. In performing alert and notification handling, when alerts or notifications are generated by other components of the system, the TCU module 546 may broadcast these messages to all group members. In performing external data integration, the module may receive and process external data such as weather updates, trail conditions, or traffic information, which can be helpful for route planning and safety considerations during the group ride. In performing geofencing and boundary management, the TCU module 546 may monitor the vehicle's position relative to predefined geographical boundaries or restricted areas, generating alerts if these boundaries are approached or crossed. By integrating with other components of the group ride communication system 540, such as the IVI module 542, ECU module 544, and RIDE Command module 548, the TCU module 546 ensures that all vehicles in the group maintain consistent and up-to-date information throughout the ride. This seamless communication enables better coordination, enhances safety, and improves the overall experience of group rides.

The RIDE Command module 548 may handle parental control settings for the group ride system. This module may interface with the operator interface 250 to allow parents or group leaders to set and adjust ride parameters.

The RIDE Command module 548 as part of the group ride communication system 540 may manage and coordinate various aspects of the group ride experience. The module may handle parental control settings, allowing parents or group leaders to set and adjust ride parameters for younger or less experienced riders. The RIDE Command module 548 may interface with the operator interface 250 to provide a user-friendly way for setting these controls.

In the context of group rides, the RIDE Command module 548 may also manage waypoint information, facilitating route planning and navigation for the entire group. It may work in conjunction with the IVI module 542 to display this information to riders, ensuring that all participants are aware of the planned route and any scheduled stops.

The RIDE Command module 548 may also play a role in coordinating group-wide settings and controls. For example, it may allow the group leader to set speed limits for the entire group, establish communication protocols, or define ride formation parameters. These group-wide settings can help maintain safety and cohesion during the ride.

Additionally, the RIDE Command module 548 may integrate with other components of the group ride communication system 540, such as the ECU module 544 and TCU module 546, to gather and process data relevant to group ride management. This integration allows the module to make informed decisions about ride parameters based on real-time vehicle data and communication needs.

By serving as a management component within the group ride communication system 540, the RIDE Command module 548 enhances the overall coordination and safety of group rides, providing tools for effective leadership and ensuring that all participants can enjoy a well-organized and secure riding experience.

The modules 542, 544, 546, and 548 in FIG. 6 correspond directly to the modules 462, 464, 466, and 468 in FIG. 5, respectively. Both sets of modules represent the same components of the group ride range monitoring system, but they are depicted in different contexts within the two figures. The IVI module 542 in FIG. 6 corresponds to the IVI 462 in FIG. 5. The ECU module 544 in FIG. 6 corresponds to the ECU 464 in FIG. 5. The TCU module 546 in FIG. 6 corresponds to the TCU 466 in FIG. 5. The RIDE Command module 548 in FIG. 6 corresponds to the RIDE Command system 468 in FIG. 5. In FIG. 5, the modules are shown as part of the vehicle integration components 460, illustrating how they integrate with the vehicle's existing systems. In FIG. 6, the same modules are depicted in relation to the group ride communication system 540, emphasizing their roles in facilitating communication and data exchange within the group ride context.

The parallel representation across FIGS. 5 and 6 helps to illustrate how the IVI, ECU, TCU, and RIDE Command components function both as part of the vehicle's internal systems and as part of the broader group ride communication network, showing the dual nature of these modules in serving both individual vehicle operations and group coordination functions. The different contexts in FIG. 5 and FIG. 6 illustrate the dual functionality of the modules within the group ride range monitoring system. In FIG. 5, the modules (IVI, ECU, TCU, and RIDE Command) are presented as integral components of an individual vehicle's systems. The context of FIG. 5 shows how these modules may interact with and integrate into the existing vehicle architecture, highlighting their role in processing and managing data within a single vehicle. FIG. 6, on the other hand, places the same modules in the context of the broader group ride communication system. The perspective showcases how these components facilitate inter-vehicle communication and data exchange, enabling the coordination of multiple vehicles during a group ride. In this context, the modules may serve as links between individual vehicles and the larger group, allowing for the sharing of status information, range data, and other relevant parameters across the entire group of participating vehicles.

The IVI 462, for instance, in FIG. 5 is shown as part of the vehicle's internal interface system, potentially managing the display of information to the driver. In FIG. 6, the IVI module 542 may be a conduit for sharing trail regulations and related data among all vehicles in the group ride. Similarly, the ECU 464 in FIG. 5 is presented as part of the vehicle's engine management system, while in FIG. 6 the ECU module 544 may report vehicle status and diagnostic information to the group. The TCU 466 can transition from being a component of the vehicle's telematics system in FIG. 5 to a facilitator of vehicle-to-vehicle and vehicle-to-infrastructure communications in FIG. 6. Lastly, the RIDE Command module 468 can shift from being an internal system for managing vehicle operations in FIG. 5 to a component that handles group-wide settings and controls, such as parental control features, in the context of FIG. 6. The dual representation shows the versatility and interconnected nature of these modules, demonstrating how they seamlessly transition between serving individual vehicle needs and contributing to the larger group ride ecosystem. The system can integrate with each vehicle's operations while simultaneously facilitating the complex interactions required for coordinated group travel.

In some implementations, the group ride range monitoring system may include a group ride system 610 that coordinates the functions of other modules as illustrated in FIG. 7.

The group ride system 610 may be connected to a vehicle communication module 620, which may handle the exchange of information between vehicles participating in the group ride. The vehicle communication module 620 may utilize the network components 182 to facilitate data transmission between vehicles.

A range analysis module 630 may be connected to the group ride system 610. The range analysis module 630 may be responsible for analyzing the range capabilities of the vehicles in the group. In some cases, the range analysis module 630 may interface with the range calculator 432 to determine individual and group range limitations.

An alert generation module 640 may also be linked to the group ride system 610. The alert generation module 640 may be tasked with generating alerts based on the information processed by the other modules. In some implementations, the alert generation module 640 may work in conjunction with the alert generator 426 to create and distribute alerts to group members.

The vehicle communication module 620, range analysis module 630, and alert generation module 640 may perform functions similar to those described in the communication module 420 and analysis module 430 from FIG. 5.

The group ride range monitoring system may also include a communication system 710 as illustrated in FIG. 8. The communication system 710 may be connected to three subordinate modules: an information sharing module 720, a limitation communicator 730, and a warning system 740. These connections may allow for efficient data flow and coordination within the group ride monitoring system.

The information sharing module 720 may handle the exchange of range-related data between vehicles participating in the group ride. In some cases, the information sharing module 720 may utilize the status broadcaster 422 to transmit range information to all group members.

The limitation communicator 730 may be responsible for transmitting information about individual vehicle limitations within the group. The limitation communicator 730 may interface with the limitation analyzer 438 to identify and communicate vehicle-specific constraints that may affect the group ride.

The warning system 740 may process diagnostic data and generate warnings for the group based on vehicle status information. In some implementations, the warning system 740 may work in conjunction with the alert notifications 416 to display important messages or warnings to riders.

These modules may align with the functions described in the communication module 420 and alert generation capabilities mentioned in previous figures.

By integrating these various modules and systems, the group ride range monitoring system may facilitate comprehensive data flow and communication between vehicles, enabling effective management of group rides and timely dissemination of critical information to all participants.

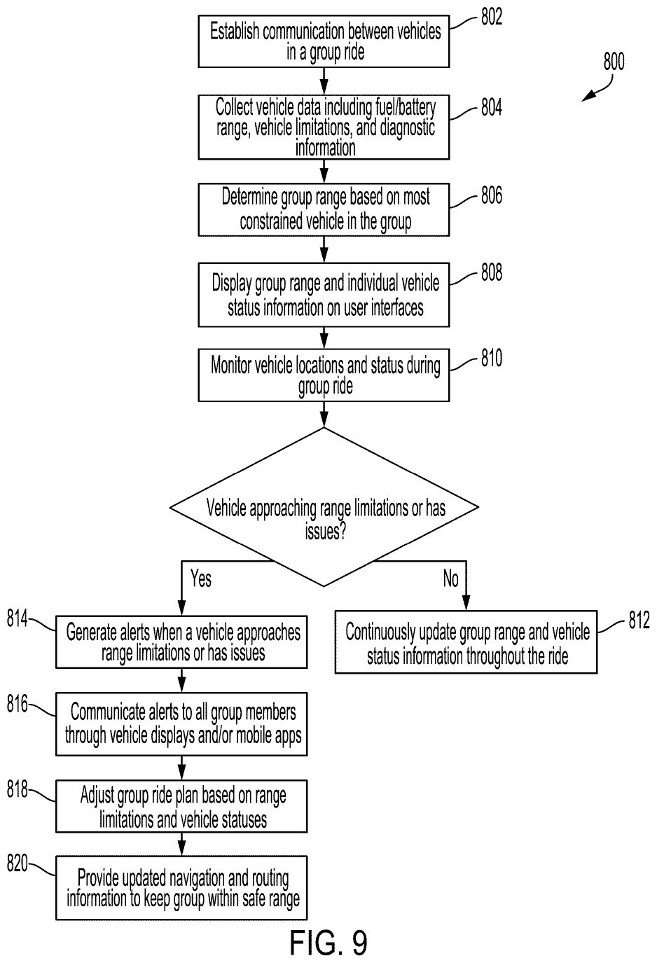

In some cases, the group ride range monitoring system may operate according to a method 800 as illustrated in FIG. 9. The method 800 may comprise several steps for managing a group ride, from establishing communication to providing updated navigation information.

The method 800 may begin with a step 802, where communication may be established between vehicles in a group ride. In some cases, the wireless communication module 18 may facilitate this communication, potentially utilizing the local wireless communication module 24 or the distance wireless communication module 26 depending on the proximity of the vehicles.

A step 804 may involve collecting vehicle data, including fuel or battery range, vehicle limitations, and diagnostic information. The ECU (Electronic Control Unit) 12 may gather this data from various vehicle systems connected to the controller area network (CAN) 14, such as the throttle 30, the accelerator 32, and the wheel speed sensor 34.

In a step 806, the group range may be determined based on the most constrained vehicle in the group. The group management controller 186 may analyze the collected data to identify which vehicle has the most limited range or capabilities.

A step 808 may involve displaying the group range and individual vehicle status information on user interfaces. The gauge 16 or other output devices 154 may present this information to riders.

The method 800 may continue with a step 810, where vehicle locations and status may be monitored during the group ride. The GPS module 22 and the location determiner 184 may provide continuous updates on vehicle positions.

In some cases, a step 812 may involve continuously updating the group range and vehicle status information throughout the ride. The group management controller 186 may process incoming data and adjust the group range as conditions change.

If a vehicle approaches range limitations or experiences issues, a step 814 may generate alerts for the affected vehicle. These alerts may be communicated to all group members through vehicle displays and/or mobile apps in a step 816.

The method 800 may include a step 818, where the group ride plan may be adjusted based on range limitations and vehicle statuses. The group management master controller 300 may coordinate with individual vehicles to modify the route or schedule as needed.

Finally, in a step 820, updated navigation and routing information may be provided to keep the group within a safe range. The network controller 180 may transmit this information to each vehicle's operator interface 150 for display.

By following this method 800, the group ride range monitoring system may help ensure that all vehicles in a group ride remain within their operational limits and reach their destination safely.

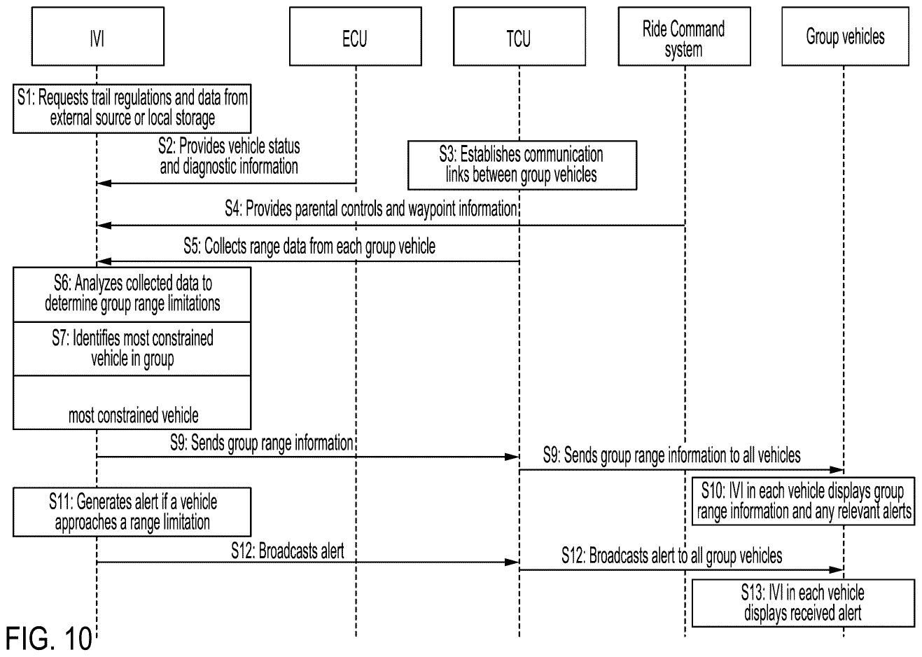

In some cases, the group ride range monitoring system may operate according to a sequence of interactions and communications as illustrated in FIG. 10. The sequence may begin with the In-Vehicle Infotainment system (IVI) requesting trail regulations and data from an external source or local storage (S1). This information may be crucial for determining route feasibility and vehicle compatibility with the planned trail.

Following the trail data request, the Engine Control Unit (ECU) may provide vehicle status and diagnostic information to the IVI (S2). This data may include fuel levels, battery charge, and any potential mechanical issues that could affect the vehicle's range or performance during the group ride.

The Telematics Control Unit (TCU) may then establish communication links between group vehicles (S3). This step may enable the sharing of vital information among all participants in the group ride, facilitating coordinated decision-making and real-time updates.

In some cases, the RIDE Command system may provide parental controls and waypoint information to the IVI (S4). This feature may allow for enhanced safety measures and predetermined route planning, especially useful for group rides involving younger or less experienced riders.

The IVI may then collect range data from each group vehicle (S5). This step may involve aggregating information about fuel levels, battery charge, and estimated range based on current conditions and terrain.

Following data collection, the IVI may analyze the collected data to determine group range limitations (S6). This analysis may take into account factors such as fuel efficiency, battery consumption rates, and individual vehicle capabilities.

The IVI may then identify the most constrained vehicle in the group (S7). This determination may be based on factors such as lowest fuel level, shortest battery range, or most limiting vehicle specifications.

Based on the identified constraints, the IVI may calculate the overall group range (S8). This calculation may consider the capabilities of the most limited vehicle to ensure that the entire group can safely complete the planned route.

In some cases, the IVI may send group range information to the TCU, which may then broadcast this information to all group vehicles (S9). This step may ensure that all participants are aware of the group's limitations and can plan accordingly.

The IVI in each vehicle may then display the group range information and any relevant alerts (S10). This display may provide riders with a clear understanding of the group's current status and any potential issues that may affect the ride.

If a vehicle approaches a range limitation, the IVI may generate an alert (S11). This alert may be triggered by factors such as low fuel levels, decreasing battery charge, or approaching geographical boundaries.

The generated alert may be broadcast to the TCU, which may then relay the alert to all group vehicles (S12). This communication flow may ensure that all participants are promptly informed of any developing issues within the group.

Finally, the IVI in each vehicle may display the received alert (S13). This step may allow all riders to be aware of the situation and take appropriate action if necessary.

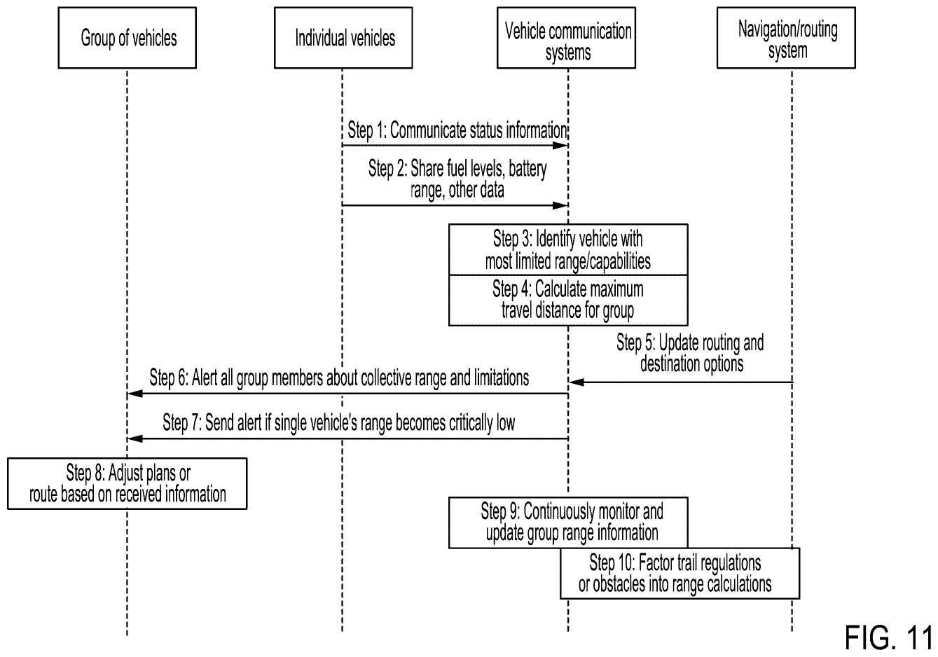

In some implementations, the group ride range monitoring system may follow a sequence of events as depicted in FIG. 11. The sequence may begin with individual vehicles communicating their status information to the vehicle communication systems (Step 1). This initial data exchange may provide a baseline for monitoring the group's overall status.

Following the initial communication, vehicles may share more detailed data including fuel levels, battery range, and other relevant information with the communication systems (Step 2). This comprehensive data sharing may allow for a more accurate assessment of the group's capabilities and limitations.

The vehicle communication systems may then identify the vehicle with the most limited range or capabilities within the group (Step 3). This identification may be crucial for determining the group's overall travel limitations.

Based on the identified limitations, the system may calculate the maximum travel distance for the entire group (Step 4). This calculation may ensure that all vehicles can safely complete the planned route without exceeding their individual capabilities.

In some cases, the navigation and routing system may update routing and destination options based on the calculated group range (Step 5). This step may involve adjusting the planned route to accommodate the group's limitations or suggesting alternative destinations within the group's range.

The system may then send an alert to all group members informing them about the collective range and any limitations (Step 6). This communication may ensure that all participants are aware of the group's capabilities and can make informed decisions about the ride.

If any single vehicle's range becomes critically low, an additional alert may be sent (Step 7). This targeted alert may allow the group to address specific issues promptly and prevent potential problems during the ride.

In response to the received information, the group of vehicles may adjust their plans or route (Step 8). This adjustment may involve modifying the ride duration, planning additional stops, or altering the route to accommodate the group's range limitations.

The vehicle communication systems may continuously monitor and update the group range information throughout the ride (Step 9). This ongoing monitoring may allow for real-time adjustments based on changing conditions or unexpected events.

In some implementations, the system may factor in trail regulations or obstacles into the range calculations (Step 10). This consideration may ensure a comprehensive assessment of the group's travel capabilities, taking into account not just vehicle limitations but also environmental and regulatory constraints.

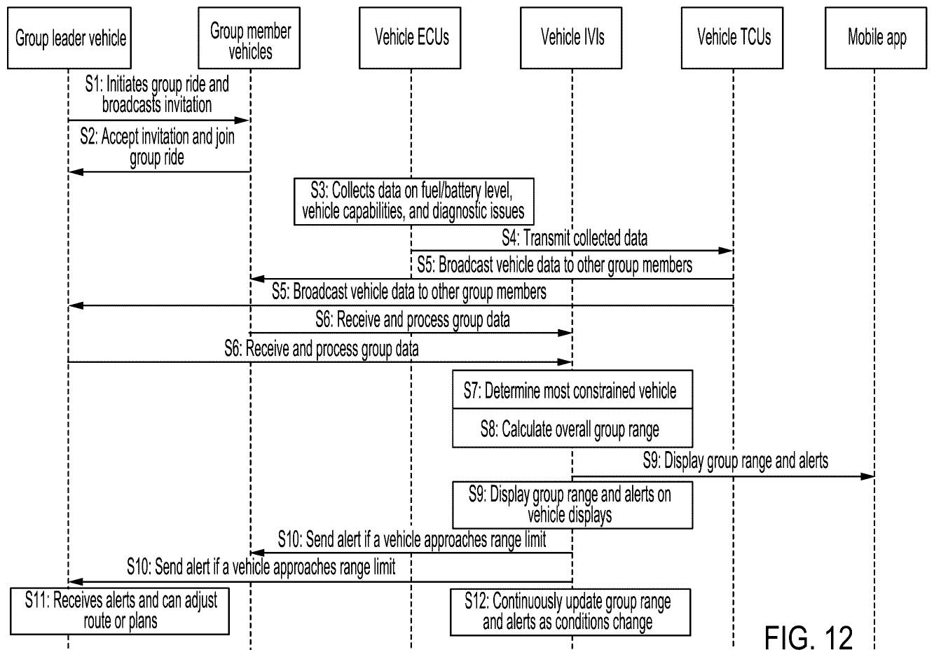

FIG. 12 illustrates another potential sequence of interactions for the group ride range monitoring system. The sequence may begin with the group leader vehicle initiating the group ride and broadcasting an invitation to potential group members (S1). This initial step may establish the framework for the group ride and allow other vehicles to join.

Group member vehicles may then accept the invitation and join the group ride (S2). This step may involve establishing communication links between all participating vehicles and the group leader.

In some cases, the vehicle ECUs may collect data on fuel and battery levels, vehicle capabilities, and diagnostic issues (S3). This data collection may provide a comprehensive overview of each vehicle's status and potential limitations.

The collected data may then be transmitted to the vehicle TCUs (S4). This transmission may facilitate the sharing of vital information among all group members.

The vehicle TCUs may broadcast the vehicle data to other group members, including the group leader vehicle (S5). This data sharing may ensure that all participants have access to up-to-date information about the entire group.

Vehicle IVIs may then receive and process this group data (S6). This processing may involve analyzing the received information to determine the group's overall status and capabilities.

Based on the processed data, the vehicle IVIs may determine the most constrained vehicle in the group (S7). This determination may be crucial for establishing the group's overall limitations.

The vehicle IVIs may then calculate the overall group range based on the identified constraints (S8). This calculation may ensure that the planned route is feasible for all participating vehicles.

In some implementations, the vehicle IVIs may display the group range and any relevant alerts on the vehicle displays (S9). This information may also be sent to associated mobile apps, providing riders with easy access to crucial ride information.

If a vehicle approaches its range limit, an alert may be sent to both the group leader vehicle and the group member vehicles (S10). This alert system may allow for prompt response to potential issues during the ride.

The group leader vehicle may receive these alerts and adjust the route or plans accordingly (S11). This adaptive planning may help ensure the safety and success of the group ride.

Throughout the ride, the vehicle IVIs may continuously update the group range and alerts as conditions change (S12). This ongoing monitoring and communication may allow for real-time adjustments and informed decision-making throughout the duration of the group ride.

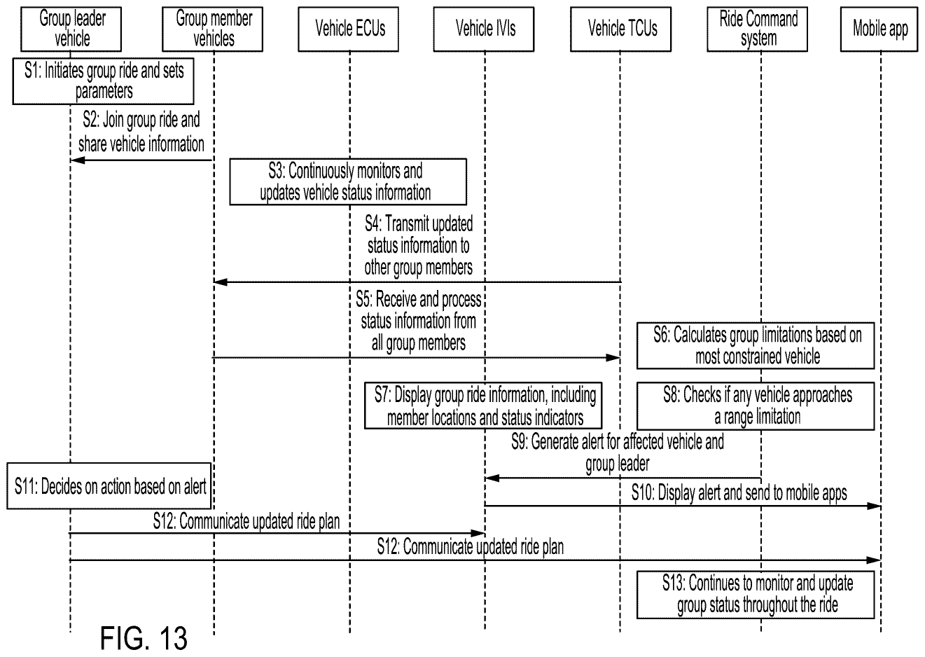

FIG. 13 depicts an additional sequence of interactions for the group ride range monitoring system. The sequence may begin with the group leader vehicle initiating the group ride and setting parameters (S1). This initial step may establish the framework and rules for the group ride.

Group member vehicles may then join the group ride and share their vehicle information with the leader (S2). This information sharing may provide the group leader with a comprehensive overview of the group's composition and capabilities.

Throughout the ride, vehicle ECUs may continuously monitor and update vehicle status information (S3). This ongoing monitoring may ensure that any changes in vehicle status are promptly detected and communicated.

Vehicle TCUs may transmit updated status information to other group members (S4). This continuous communication may keep all participants informed about the current state of each vehicle in the group.

Vehicle IVIs may receive and process status information from all group members (S5). This processing may involve analyzing the received data to maintain an up-to-date understanding of the group's overall status.

In some cases, the RIDE Command system may calculate group limitations based on the most constrained vehicle (S6). This calculation may ensure that the group's plans and route remain feasible for all participants.

Vehicle IVIs may display group ride information, including member locations and status indicators (S7). This display may provide riders with a clear visual representation of the group's current state.

The RIDE Command system may continuously check if any vehicle approaches a range limitation (S8). This ongoing monitoring may allow for early detection of potential issues.

If a limitation is detected, vehicle TCUs may generate an alert for the affected vehicle and group leader (S9). This alert system may ensure that both the affected rider and the group leader are promptly informed of the situation.

Vehicle IVIs may display the alert and send it to associated mobile apps (S10). This multi-channel communication may increase the likelihood that the alert is noticed and addressed in a timely manner.

The group leader vehicle may then decide on an action based on the received alert (S11). This decision-making process may involve adjusting the route, planning a stop, or taking other appropriate measures to address the detected limitation.

The updated ride plan may be communicated to group member vehicles and mobile apps (S12). This communication may ensure that all participants are aware of any changes to the original plan.

Throughout the ride, the RIDE Command system may continue to monitor and update group status (S13). This ongoing monitoring and communication may allow for adaptive planning and management of the group ride, ensuring a safe and enjoyable experience for all participants.

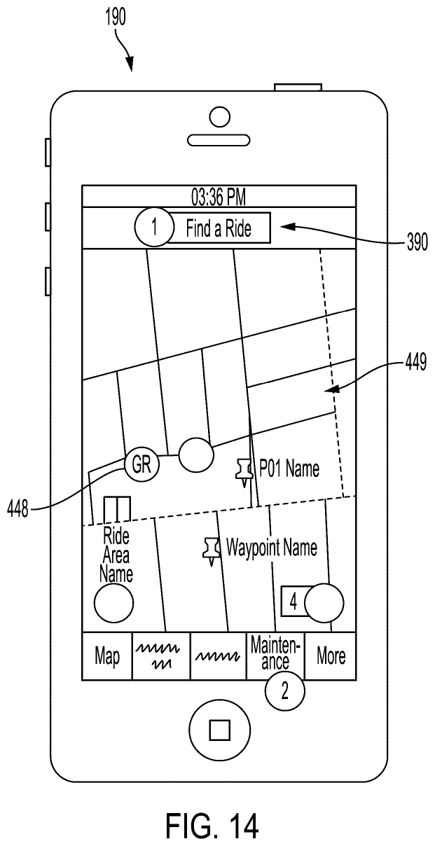

In some cases, the group ride range monitoring system may include various user interface and display features to provide riders with essential information and communication capabilities. These features may be implemented on a rider computing device 190, as shown in FIG. 14. The rider computing device 190 may display a user interface that includes a map 449 showing various routes and locations. The user interface may also include a selectable region 390 labeled “Find a Ride” at the top of the screen, allowing users to search for available rides. A graphical representative of last location 448 may be shown on the map 449, indicating a specific point or area of interest. The graphical representation of last location 448 could be used to mark important waypoints or indicate where range limitations were previously encountered.

The rider computing device 190 may refer to a portable electronic device used by participants in a group ride to access and interact with the group ride range monitoring system. This device could be a smartphone, tablet, or dedicated in-vehicle display unit specifically designed for recreational vehicles. The rider computing device typically includes a display screen, processing capabilities, and wireless communication features that allow it to receive and transmit data related to the group ride. The rider computing device 190 may include: GPS functionality for real-time location tracking, cellular or other wireless connectivity for data exchange with other group members and central systems, user interface for displaying group ride information, maps, and alerts, input mechanisms (touchscreen, buttons, or voice commands) for interacting with the system, and the ability to run specialized applications or software related to group ride management.

The rider computing device 190 may serve as an interface between the individual rider and the larger group ride monitoring system, providing real-time updates on group status, range limitations, and potential alerts. It may also allow riders to input data, acknowledge notifications, or communicate with other group members. By utilizing rider computing device 190, the group ride range monitoring system can ensure that all participants have access to critical information regardless of their vehicle's built-in display capabilities. The user interface likely displays the results of calculations performed by components like the range analysis module 630 (FIG. 7) or the limitation communicator 730 (FIG. 8), translating complex data into a user-friendly format that riders can easily understand and act upon during group rides.

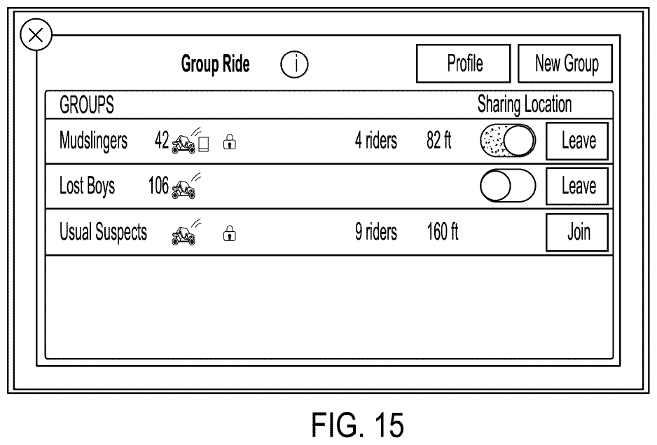

FIG. 15 illustrates a user interface for a group ride management system. The interface may display a “Group Ride” screen with various components for organizing and participating in group rides. In some cases, the interface may show a list of groups under a “GROUPS” header. Each group entry may include a group name, a vehicle icon, the number of riders, and distance information (e.g., related to the group's ride). The interface may also display a “Sharing Location” toggle for each group, allowing users to control their location visibility. This toggle provides riders with the ability to manage their privacy settings and choose when to share their real-time location with other group members. By offering this level of control, the interface balances the need for group coordination with individual privacy preferences.

This user interface may serve as a hub for riders to manage their participation in various group rides, view essential information about each group, and control their data sharing settings. The design of this interface likely incorporates data from the group ride communication system 540 (FIG. 6) and the group ride system 610 (FIG. 7), presenting complex group ride information in a user-friendly format that riders can easily understand and interact with during their recreational vehicle outings.

The user interface illustrated in FIG. 15 could be displayed on various devices associated with the group ride range monitoring system, such as the vehicle's built-in display system or rider computing device, such as a smartphone or tablet. The flexibility allows riders to access and interact with the group ride management system even if their vehicle lacks an integrated display capable of showing such detailed information.

The built-in display system may be the visual interface integrated into the vehicle's dashboard or console, which presents information to the driver and passengers. This display may be part of a larger onboard system that includes various electronic components and software.

The onboard system, often referred to as the vehicle's infotainment system or In-Vehicle Infotainment (IVI) system, encompasses a broader range of functionalities. It may include the display, audio system, navigation, vehicle diagnostics, and connectivity features. The onboard system is the comprehensive electronic ecosystem that manages and integrates various vehicle functions and user interfaces.

In the context of the group ride range monitoring system, the built-in display system may be used to present information from the onboard system, including data related to group ride status, range limitations, and alerts. The onboard system may process the data received from various vehicle components and external sources, while the built-in display system may serve as the visual output for this information.

In some cases, the distinction between the built-in display system and the broader onboard system may be less clear, as advanced integrated systems combine multiple functions into a single, cohesive interface. However, for the purposes of the group ride range monitoring system, the built-in display system can be considered the visual interface through which riders interact with the broader onboard system and its group ride management features.

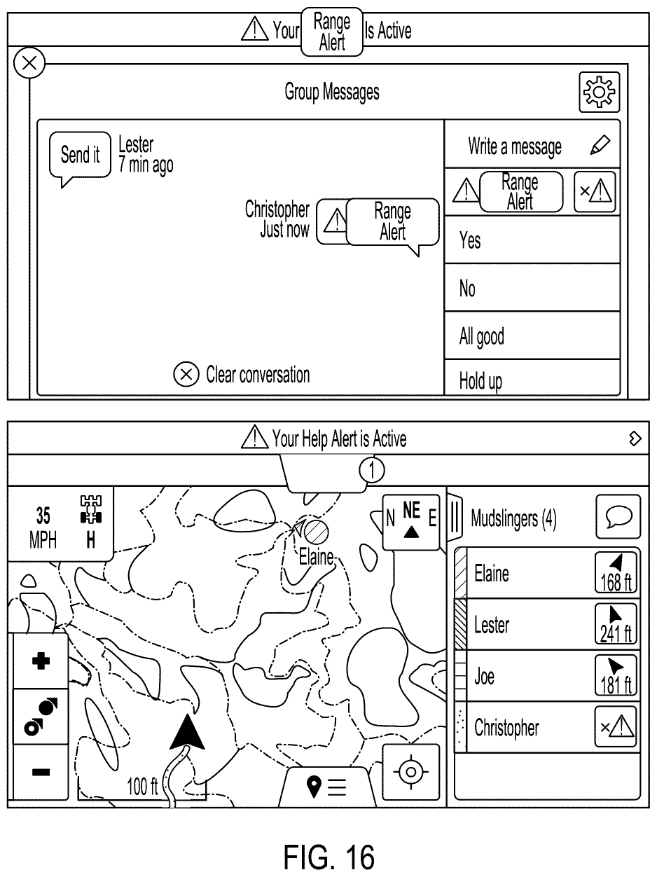

FIG. 16 illustrates a user interface for a group ride monitoring and communication system. The interface may be divided into two main sections: a group messaging window at the top and a map display with rider information at the bottom. In some cases, the group messaging window may display recent messages from group members, including alerts such as a “Range Alert” notification. The lower portion of the interface may show a topographical map with rider locations. A speed indicator 35 may be displayed, showing the current speed.

The user interface for the group ride monitoring system may be displayed on various devices. On built-in vehicle displays, the interface may be integrated into the vehicle's dashboard or console display, providing riders with easy access to group ride information while operating their vehicle. As part of rider computing devices, this could include smartphones, tablets, or dedicated handheld devices specifically designed for use with recreational vehicles. These portable devices allow riders to access group ride information even when away from their vehicle. As part of wearable devices, smartwatches or other wearable technology may display simplified versions of the interface, providing quick access to essential information and alerts. On remote monitoring stations, for group ride organizers or support teams, the interface may be accessible on desktop computers or larger displays at a central location.

Regarding the range alert in the context of the most constrained limitation, the feature may ensure the safety and efficiency of the group ride. The system may continuously monitor the range capabilities of all vehicles in the group and identifies the vehicle with the most limited range as the constraining factor for the entire group. When this most constrained vehicle approaches its range limitation, the system generates a range alert. The alert may notify all group members about the impending range limitation, allowing for collective decision-making regarding route adjustments or refueling stops. The alert may prevent situations where the group might inadvertently exceed the capabilities of its most limited member, potentially leaving a vehicle stranded. The alert may encourage proactive planning and coordination among group members to ensure that all vehicles can safely complete the planned route.

The range alert may be displayed prominently on all connected devices, using visual cues such as color changes or flashing icons to draw attention to the situation. This ensures that all group members, regardless of their individual vehicle's capabilities, are aware of the group's overall range limitations and can adjust their expectations or plans accordingly.

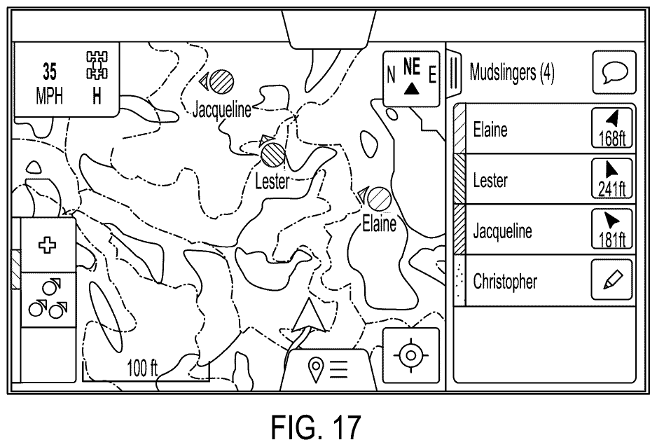

FIG. 17 illustrates a user interface for a group ride monitoring system. The interface may display a map view showing the locations of multiple riders participating in a group ride. In some cases, the map may include topographical features or terrain information to provide context for the ride environment.

The interface may show rider icons representing the positions of different group members on the map. Each rider icon may be accompanied by identifying information such as a rider name or number. The interface may also display status indicators next to each rider icon, providing at-a-glance information about factors like fuel level, battery charge, or current speed.

A group range indicator may be prominently displayed, showing the current range limitation for the entire group based on the most constrained vehicle. This indicator may be color-coded or use other visual cues to quickly communicate the group's overall range status.

The interface may include a route line or path showing the planned or current trajectory of the group ride. Waypoints or points of interest along the route may be marked with distinct icons.

Additional information panels or widgets may be present on the interface, potentially showing details such as current group speed, estimated time to destination, weather conditions, and upcoming terrain challenges. The interface may also feature controls or buttons allowing riders to interact with the system, such as options to zoom in/out on the map, send messages to the group, or adjust ride settings.

The comprehensive display integrates data from various components of the group ride range monitoring system, such as the range analysis module 630 and the alert generation module 640, to provide riders with a clear visual representation of the group's status and location during the ride.

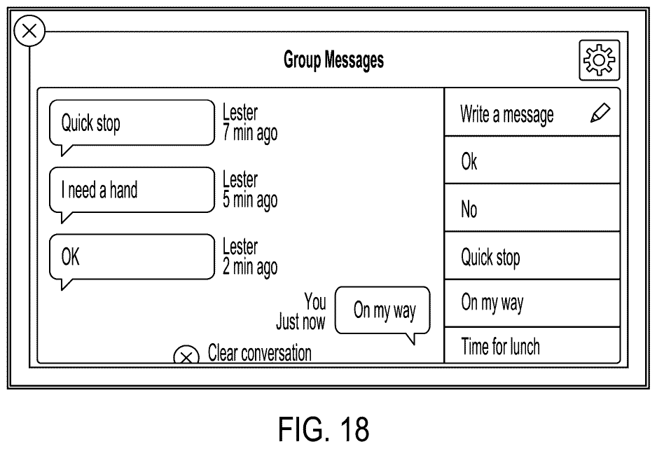

FIG. 18 depicts a user interface for a group messaging system. The interface may display a “Group Messages” window containing a conversation history and message input options. In some cases, the conversation area may show messages from group members with timestamps indicating when each message was sent. The interface may include a “Write a message” field and a list of quick message options such as “Ok,” “No,” “Quick stop,” “On my way,” and “Time for lunch.”

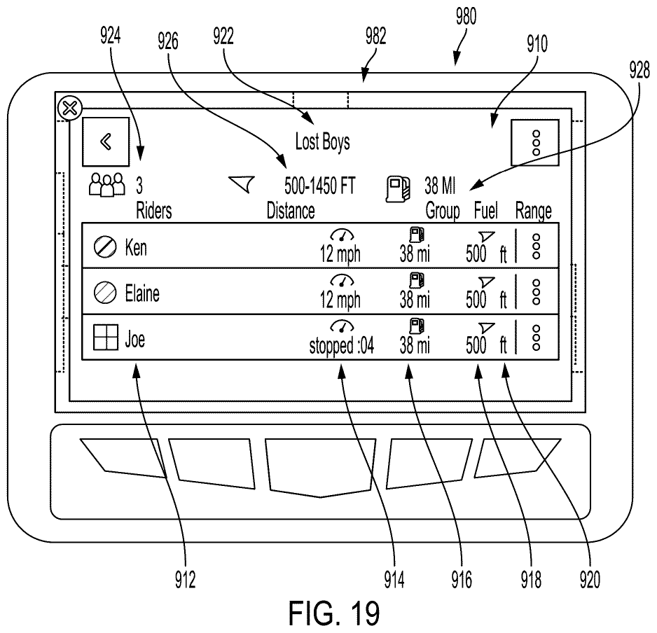

FIG. 19 depicts a user interface 910 for a group ride monitoring system. The user interface 910 may be displayed on a display 982 (e.g., touch display) of a device. In some cases, the interface may provide information about a group ride and its participants. At the top of the user interface 910, a group name 922 may be displayed, along with a rider count 924. A distance range 926 and a group fuel range 928 may also be shown. The main area of the user interface 910 may present a table with information about each rider in the group, including a group member name 912, speed indicator 914, fuel range indicator 916, and distance indicator 918.

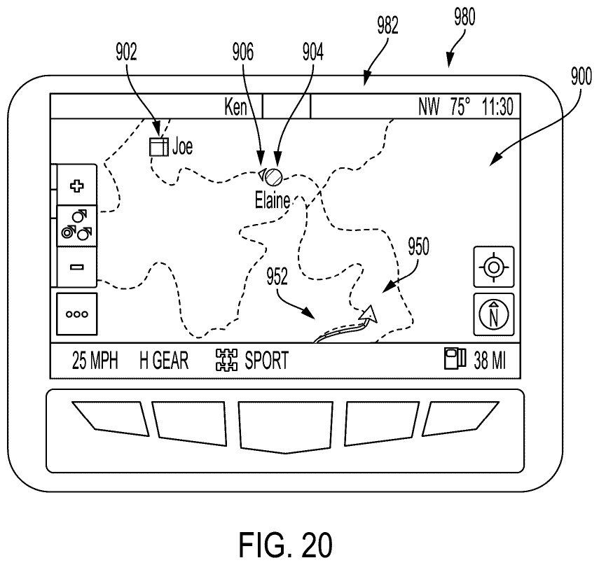

FIG. 20 illustrates a display device 900 for a group ride monitoring system. The display device 900 may include a user interface 980 presented on a touch display 982. In some cases, the user interface 980 may show a map view with various elements representing riders and their positions. The interface may display rider icons, including a first rider icon 902, a second rider icon 904, and a third rider icon 950. A direction indicator 906 may be shown pointing towards one of the rider icons. A route 952 may be depicted on the map as a dotted line, showing the path taken or planned for the group ride.

These user interface and display features may work in conjunction with the vehicle control system 10, utilizing data from components such as the ECU 12, the GPS module 22, and the wireless communication module 18 to provide real-time information and communication capabilities to riders participating in group rides.

Once the most constrained limitation has been determined, travel outside the boundary based on the limitation may be managed by the TCU module, GPS module, group management controller, RIDE Command system, range analysis module, limitation analyzer, IVI module, and/or group ride system. The TCU module may manage vehicle-to-vehicle and vehicle-to-infrastructure communications. It could utilize the GPS module to continuously track vehicle locations and compare them against predefined geographical boundaries or restricted areas. The TCU may generate alerts when a vehicle approaches or crosses a defined boundary, transmitting this information to the vehicle's display system and other vehicles in the group. The GPS module may provide location data that enables geofencing functionality. The GPS module may continuously update the vehicle's position, which other components use for boundary comparisons. The group management controller could integrate geofencing logic to monitor the entire group's position relative to defined boundaries; It could process location data from all vehicles to ensure the group as a whole stays within permitted areas. As the RIDE Command system can handle parental controls and waypoint information, the RIDE Command system could incorporate geofencing features, especially for setting up safe riding zones for younger or less experienced riders. The range analysis module could factor in geographical boundaries when calculating range limitations, ensuring that range estimates consider not just vehicle capabilities but also permitted riding areas. As part of the analysis module, the limitation analyzer could include geographical constraints in its assessment of factors affecting the group ride. The IVI could display geofence-related alerts and boundary information to riders. The group ride system could coordinate geofencing data from various modules, integrating boundary information into overall ride management.

To implement geofencing and boundary management, these components could work together to store predefined boundaries during ride setup or planning, continuously monitor vehicle locations using GPS data, compare real-time locations against stored boundary data, generate alerts when boundaries are approached or crossed, transmit alerts to affected vehicles and the group, integrate boundary constraints into range calculations and ride planning, or display relevant boundary information on vehicle interfaces or mobile apps. Using a multi-component approach could ensure comprehensive geofencing and boundary management throughout the group ride experience.

In some cases, the TCU module can perform the majority, if not all, the geofencing and boundary management for the group ride range monitoring system. The TCU module, as described in the application, may manage vehicle-to-vehicle and vehicle-to-infrastructure communications. The TCU may also handle data collection, processing, and transmission between vehicles and external systems. To implement geofencing and boundary management, the TCU module can utilize the GPS module (mentioned in the vehicle control system description) to continuously track the vehicle's location. The TCU can then compare this real-time location data against predefined geographical boundaries or restricted areas that have been programmed into the system. The process can work as follows: During ride setup or planning, geographical boundaries could be defined and stored in the system. These could include permitted riding areas, off-limits zones, or specific routes. As the group ride progresses, the TCU module in each vehicle can constantly monitor its GPS location. The TCU can compare the current location to the stored boundary data. If a vehicle approaches or crosses a defined boundary, the TCU can generate an alert. This alert can be transmitted to the vehicle's own display system and potentially broadcast to other vehicles in the group through the vehicle-to-vehicle communication capabilities of the TCU. The alert could trigger various responses, such as warnings on the vehicle's display, audible alarms, or even automatic speed reduction depending on the system's capabilities and settings.

In some cases, the TCU module could also work in conjunction with the group ride system and the range analysis module to factor in these geographical constraints when calculating group range limitations. This integration would ensure that the overall group ride management takes into account not just vehicle capabilities and fuel/battery ranges, but also permitted riding areas and restricted zones.

The following clauses illustrated example subject matter described herein.
Clause 1. A group ride management system for vehicles, comprising: a communication module configured to establish communication between vehicles in a group ride; a range analysis module configured to collect vehicle data including fuel or battery range and vehicle limitations; and an analysis module configured to determine a group range based on the most constrained vehicle in the group, wherein the analysis module is further configured to generate alerts when a vehicle approaches range limitations.
Clause 2. The group ride management system of Clause 1, further comprising a display module configured to display the group range and individual vehicle status information on user interfaces of the vehicles in the group ride.
Clause 3. The group ride management system of Clause 1 or Clause 2, wherein the range analysis module is further configured to collect diagnostic information from the vehicles.
Clause 4. The group ride management system of any one of Clauses 1 through 3, wherein the analysis module is further configured to adjust a group ride plan based on range limitations and vehicle statuses.
Clause 5. The group ride management system of any one of Clauses 1 through 4, wherein the analysis module is further configured to adjust a group ride plan based on range limitations and vehicle statuses, and wherein adjusting the group ride plan comprises providing updated navigation and routing information to keep the group within a safe range.
Clause 6. The group ride management system of any one of Clauses 1 through 5, wherein the vehicle limitations include trail width restrictions and vehicle capabilities.
Clause 7. The group ride management system of any one of Clauses 1 through 6, wherein the communication module is further configured to communicate with a mobile application on a user device without a vehicle display.
Clause 8. A method for managing a group ride for vehicles, comprising: establishing communication between vehicles in a group ride; collecting vehicle data including fuel or battery range and vehicle limitations; determining a group range based on the most constrained vehicle in the group; displaying the group range and individual vehicle status information on user interfaces; and generating alerts when a vehicle approaches range limitations.
Clause 9. The method of Clause 8, further comprising collecting diagnostic information from the vehicles in the group ride.
Clause 10. The method of Clause 8 or Clause 9, further comprising adjusting a group ride plan based on range limitations and vehicle statuses.
Clause 11. The method of any one of Clauses 8 through 10, further comprising adjusting a group ride plan based on range limitations and vehicle statuses, wherein adjusting the group ride plan comprises providing updated navigation and routing information to keep the group within a safe range.
Clause 12. The method of any one of Clauses 8 through 11, wherein the vehicle limitations include trail width restrictions and vehicle capabilities.
Clause 13. The method of any of Clauses 8 through 12, further comprising communicating with a mobile application on a user device.
Clause 14. The method of any of Clauses 8 through 13, further comprising communicating with a mobile application on a user device, wherein the mobile application displays the group range and individual vehicle status information on the user device.
Clause 15. A non-transitory computer-readable medium storing instructions that, when executed by a processor, cause the processor to perform operations for managing a group ride for vehicles, the operations comprising: establishing communication between vehicles in a group ride; collecting vehicle data including fuel or battery range and vehicle limitations; determining a group range based on the most constrained vehicle in the group; and generating alerts when a vehicle approaches range limitations.
Clause 16. The non-transitory computer-readable medium of Clause 15, wherein the operations further comprise displaying the group range and individual vehicle status information on user interfaces of the vehicles in the group ride.
Clause 17. The non-transitory computer-readable medium of Clause 15 or Clause 16, wherein the vehicle limitations include trail width restrictions and vehicle capabilities.
Clause 18. The non-transitory computer-readable medium of any one of Clauses 15 through 17, wherein the operations further comprise adjusting a group ride plan based on range limitations and vehicle statuses.
Clause 19. The non-transitory computer-readable medium of any one of Clauses 15 through 18, wherein the operations further comprise adjusting a group ride plan based on range limitations and vehicle statuses, and wherein adjusting the group ride plan comprises providing updated navigation and routing information to keep the group within a safe range.
Clause 20. The non-transitory computer-readable medium of any of Clauses 15 through 19, wherein the operations further comprise communicating with a mobile application on a user device, wherein the mobile application displays the group range and individual vehicle status information on the user device.

A number of implementations have been described. Nevertheless, it will be understood that various modifications may be made without departing from the spirit and scope of the disclosure. Accordingly, other implementations are within the scope of the following claims.

What is claimed is:

1. A method for monitoring range limitations in a group ride, wherein the method comprises:
receiving, via a wireless communication interface, from a plurality of vehicles participating in a group ride, status data comprising at least one of fuel level data, battery charge data, diagnostic data, time constraints, and geographical boundary constraints;
analyzing, by processing circuitry, the status data to determine a range limitation for each vehicle of the plurality of vehicles;
identifying, by the processing circuitry, a most constrained range limitation from among the determined range limitations as a group range limitation;
transmitting, via the wireless communication interface, to each vehicle of the plurality of vehicles, the group range limitation; and
automatically managing, by the processing circuitry, travel of each vehicle in the group ride within the group range limitation.

2. The method of claim 1, wherein the method further comprises:
receiving, by the processing circuitry, trail regulation data for a planned route of the group ride, wherein the trail regulation data comprises at least one of trail width restrictions, vehicle size limitations, and trail difficulty ratings; and
determining, by the processing circuitry, based on the trail regulation data, a vehicle compatibility, wherein the status data further comprises the vehicle compatibility.

3. The method of claim 1, wherein the method further comprises generating, by the processing circuitry, an alert when a vehicle in the group ride approaches the group range limitation.

4. The method of claim 1, wherein the transmitting comprises displaying the most constrained range limitation and an identifier of a vehicle associated with the most constrained range limitation on a graphical user interface of each vehicle of the plurality of vehicles.

5. The method of claim 1, wherein the transmitting comprises displaying a map interface showing locations of the plurality of vehicles with visual indicators of their respective range limitations on a graphical user interface of each vehicle.

6. The method of claim 1, further comprising:
receiving a destination location for the group ride;
determining whether the most constrained range limitation permits completion of a route to the destination location; and
generating a warning notification when the most constrained range limitation is insufficient for completing the route.

7. The method of claim 1, wherein the transmitting, to each vehicle of the plurality of vehicles, the group range limitation, comprises transmitting to at least one of a display device integrated with each vehicle, a mobile device associated with each vehicle, and a remote monitoring station.

8. The method of claim 1, further comprising adjusting the group range based on real-time updates of the status data.

9. A system for coordinating group vehicle travel, comprising:
a communication interface configured to collect status data from a plurality of vehicles in a group;
a processing circuitry configured to:
determine, based on the status data, individual range capabilities for each vehicle of the plurality of vehicles;
determine, based on a most limited range capability among the individual range capabilities, a group travel constraint; and
generate an alert when at least one vehicle approaches the group travel constraint; and
a display configured to present the alert to operators of the plurality of vehicles.

10. The system of claim 9, wherein the status data comprises at least one of fuel level data, battery charge level data, diagnostic trouble codes, vehicle specification data, time constraints, and geographical boundary constraints.

11. The system of claim 9, wherein the processing circuitry is further configured to:
receive trail regulation data for a planned route; and
determine whether each vehicle's specifications comply with the trail regulation data.

12. The system of claim 9, wherein the display is configured to generate a map interface showing locations of each of the plurality of vehicles with respective visual indicators representing respective range capabilities, and wherein the respective visual indicators are configured to change appearance when a respective vehicle of the plurality of vehicles approaches the group travel constraint.

13. The system of claim 9, wherein the processing circuitry is further configured to:
receive data indicative of a destination location;
determine, based on the group travel constraint, whether the most limited range capability permits completion of a route to the destination location; and
generate a notification when the most limited range capability is insufficient for completing the route.

14. The system of claim 9, wherein the alerts are transmitted to at least one of an in-vehicle display device, a mobile device associated with a vehicle operator, and a remote monitoring station.

15. A vehicle comprising:
a communication interface configured to communicate with one or more vehicles in a group ride;
one or more sensors configured to monitor one or more vehicle operating parameters affecting vehicle range;
a processing circuitry configured to:
determine, based on the operating parameters, a vehicle range;
receive, from the one or more vehicles, range data;
compare the vehicle range with the range data to generate a comparison; and
generate, based on the comparison, an alert when any of the vehicle or the one or more vehicles in the group ride approaches a range limitation; and
a display configured to present the alert to an operator.

16. The vehicle of claim 15, wherein the operating parameters comprise at least one of fuel level, battery charge level, diagnostic trouble codes, and vehicle specifications affecting trail compatibility.

17. The vehicle of claim 15, wherein the processing circuitry is further configured to:
receive trail regulation data for a planned route; and
determine whether the vehicle specifications comply with the trail regulation data.

18. The vehicle of claim 15, wherein the display is configured to generate a map interface showing locations of the vehicles in the group ride and visual indicators representing their respective ranges.

19. The vehicle of claim 15, wherein the visual indicators comprise icons that change appearance based on remaining range.

20. The vehicle of claim 15, wherein the processing circuitry is further configured to:
receive a destination location for the group ride;
calculate whether the ranges of all vehicles permit completion of a route to the destination location; and
generate a warning notification when any vehicle's range is insufficient for completing the route.
